(19) United States
(12) Patent Application Publication
(10) Pub. No.: US 2026/0252553 A1
(43) Pub. Date: Aug. 27, 2026

(54) BLOCKCHAIN SYSTEM, NODE, AND PROGRAM

(71) Applicant: KYOCERA Corporation, Kyoto (JP)

(72) Inventors: Yoshihiro TAKAHASHI, Yokohama-shi (JP); Satoko ISHIHARA, Yokohama-shi (JP); Haeseung JUNG, Yokohama-shi (JP); Masashi FUJISAWA, Yokohama-shi (JP); Hiroyuki YAMASHITA, Fuchu-shi (JP)

(73) Assignee: KYOCERA Corporation, Kyoto (JP)

(21) Appl. No.: 18/879,162

(22) PCT Filed: Jun. 21, 2023
(86) PCT No.: PCT/JP2023/023012

§ 371 Date: Dec. 26, 2024

(30) Foreign Application Priority Data
Jun. 28, 2022 (JP) 2022-104031

(51) Int. Cl. G06F 16/23

(52) U.S. Cl. CPC G06F 16/2379; G06F 16/2343

(57) ABSTRACT

In a blockchain system in which a network with a hierarchical structure is formed by a plurality of nodes, a node belonging to a first group of a first layer different from a lowest layer manages a first ledger including transaction data related to a transaction in the first group and performs ledger locking to not update the first ledger during a lock period after the first ledger is updated. If a second ledger managed by a second group in a second layer lower than the first layer has been updated within the lock period when the lock period ends, the node updates the first ledger to include, in the first ledger, ledger information related to the updated second ledger.

### TECHNICAL FIELD

The present disclosure relates to a blockchain system, a node, and a program.

### BACKGROUND OF INVENTION

In recent years, blockchain technology has been attracting attention. The blockchain technology has an advantage in that system outages do not occur since an autonomous distributed network, to be specific, a Peer to Peer (P2P) network is formed by a plurality of nodes.

The blockchain technology has a mechanism in which each node manages transaction history in the P2P network as a ledger. Such a mechanism is also referred to as distributed ledger technology. When a transaction occurs in one node, calculation (verification) processing is performed in all participating nodes. This provides a mechanism that leaves a correct transaction history that is very difficult to tamper with even when fraud occurs in a participating node and/or the participating node does not operate normally.

Patent Document 1 describes a system in which a P2P network is divided into a plurality of hierarchical networks and transaction data is managed independently for each network in order to solve the problem of capacity shortage in nodes due to significant increase of the transaction history (ledger) held in each node. In this system, when a transaction partner is present in a network of the system, transaction data is shared and stored only in the network of the system.

### CITATION LIST

### Patent Literature

Patent Document 1: JP 2018-67108 A

### SUMMARY

In a first aspect, a blockchain system is a blockchain system in which a network with a hierarchical structure is formed by a plurality of nodes. A node belonging to a first group in a first layer different from a lowest layer is configured to manage a first ledger including transaction data related to a transaction in the first group, and perform ledger locking to not update the first ledger during a lock period after the first ledger is updated. If a second ledger managed by a second group in a second layer lower than the first layer has been updated within the lock period when the lock period ends, the node updates the first ledger to include, in the first ledger, ledger information related to the updated second ledger.

In a second aspect, a node is a node belonging to a first group in a first layer different from a lowest layer in a blockchain system in which a network with a hierarchical structure is formed by a plurality of nodes. The node includes a processor configured to execute processing for managing a first ledger including transaction data related to a transaction in the first group, processing for performing ledger locking to not update the first ledger during a lock period after the first ledger is updated, and processing for, if a second ledger managed by a second group in a second layer lower than the first layer has been updated within the lock period when the lock period ends, updating the first ledger to include, in the first ledger, information related to the updated second ledger.

In a third aspect, a program causes a node belonging to a first group in a first layer different from a lowest layer in a blockchain system in which a network with a hierarchical structure is formed by a plurality of nodes to execute processing for managing a first ledger including transaction data related to a transaction in the first group, processing for performing ledger locking to not update the first ledger during a lock period after the first ledger is updated, and processing for, if a second ledger managed by a second group in a second layer lower than the first layer has been updated within the lock period when the lock period ends, updating the first ledger to include, in the first ledger, information related to the updated second ledger.

### BRIEF DESCRIPTION OF THE DRAWINGS

FIG. 1 is a diagram illustrating a configuration example of a network in a general blockchain system.

FIG. 2 is a diagram illustrating a configuration example of a ledger managed by each node according to an embodiment.

FIG. 3 is a diagram illustrating an operation example of operations performed when a new block is added to the ledger (that is, when the ledger is updated) according to the embodiment.

FIG. 4 is a diagram illustrating an operation example of operations performed when a new block is added to the ledger according to an embodiment.

FIG. 5 is a diagram illustrating a configuration example of each node according to the embodiment.

FIG. 6 is a diagram illustrating a configuration example of a network according to the embodiment.

FIG. 7 is a diagram illustrating a ledger management method according to the embodiment.

FIG. 8 is a diagram illustrating a ledger management method according to the embodiment.

FIG. 9 is a diagram for describing an effect of reducing an amount of calculation when the hierarchically structured network according to the embodiment is compared with a general network configuration.

FIG. 10 is a diagram for describing a link between an upper layer ledger and a lower layer ledger according to the embodiment.

FIG. 11 is a diagram illustrating an operation example of operations performed when group (A) is formed and subsequently group (B) is newly formed below group (A), according to the embodiment.

FIG. 12 is a diagram illustrating an operation example of operations performed when group (A) is formed, subsequently group (B) is newly formed below group (A), and further subsequently group (C) is newly formed below group (A), according to the embodiment.

FIG. 13 is a diagram illustrating an operation example of operations performed when group (A) is formed, subsequently group (B) is newly formed below group (A), and further subsequently group (C) is newly formed below group (A), according to the embodiment.

FIG. 14 is a diagram for describing grouping of lower layer groups according to the embodiment.

FIG. 15 is a diagram for describing grouping of the lower layer groups according to the embodiment.

FIG. 16 is a diagram for describing a priority in the group according to the embodiment.

FIG. 17 is a diagram for describing the priority in the group according to an embodiment.

FIG. 18 is a diagram for describing an example of node parameters stored in ledgers according to the embodiment.

FIG. 19 is a diagram for describing locking of the ledgers according to the embodiment.

FIG. 20 is a diagram for describing a lock operation for ledger update according to the embodiment.

FIG. 21 is a diagram illustrating an example of operations according to the embodiment.

FIG. 22 is a diagram for describing a method for configuring a lock period according to the embodiment.

FIG. 23 is a diagram for describing a method for configuring a lock period according to an embodiment.

FIG. 24 is a diagram illustrating Specific Example 1 of operations related to ledger locking according to the embodiment.

FIG. 25 is a diagram illustrating Specific Example 2 of operations related to ledger locking according to the embodiment.

FIG. 26 is a diagram illustrating a flow example of when a node joins a hierarchically structured network according to the embodiment.

FIG. 27 is a diagram illustrating a flow example of a parent node rotation in the hierarchically structured network according to the embodiment.

FIG. 28 is a diagram illustrating a flow example of when a node joins a lower layer (joins a lower layer group) in the hierarchically structured network according to the embodiment.

FIG. 29 is a diagram illustrating a flow example of when a node is removed in the hierarchically structured network according to the embodiment.

FIG. 30 is a diagram illustrating an example of main processing for ledger locking according to the embodiment.

FIG. 31 is a diagram illustrating an example of transaction data processing according to the embodiment.

FIG. 32 is a diagram illustrating an example of processing for searching for another node with a memory margin according to the embodiment.

FIG. 33 is a diagram illustrating an example of processing on the side of a node with a memory margin according to the embodiment.

FIG. 34 is a diagram illustrating an example of processing executed when no other node in a group has a memory margin according to the embodiment.

FIG. 35 is a diagram illustrating an example of processing executed when a ledger (child ledger) of a plurality of child groups is updated according to the embodiment.

FIG. 36 is a diagram illustrating an example of processing executed when the ledger of the child groups is updated a plurality of times according to the embodiments.

FIG. 37 is a diagram illustrating an example of processing executed when update of the child ledger fails according to the embodiment.

FIG. 38 is a diagram illustrating an example of child ledger update processing according to the embodiment.

### DESCRIPTION OF EMBODIMENTS

As in the technique described in Patent Document 1, the frequency of update and a significant increase in size of a ledger are considered to be suppressed by grouping nodes in a P2P network and individually managing a ledger for each group. However, in such a method, since the content of the ledger of each group is not linked to the ledger of another group, a problem exists in that reliability in the blockchain technology may be decreased.

An object of the present disclosure is to enable suppression of a decrease in reliability while suppressing an update frequency and increase in size of a ledger when applying the blockchain technology.

Embodiments are described with reference to the drawings. In the description of the drawings, the same or similar parts are denoted by the same or similar reference signs.

### Overview of Blockchain Technology

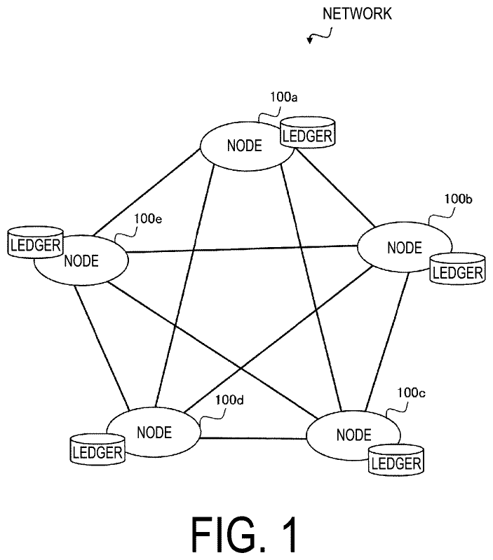

First, a general blockchain technology will be described with reference to FIGS. 1 to 4.

FIG. 1 is a diagram illustrating a configuration example of a network in the general blockchain system. In FIG. 1, lines connecting nodes represent communication connections between the nodes.

In the blockchain technology, an autonomous distributed network, to be specific, a P2P network is formed by a plurality of nodes 100. The nodes 100 are communicably connected to one another. Communication between the nodes 100 may be performed via a public communication network and/or a local communication network. Note that, although a total of five nodes 100a to 100e are illustrated in FIG. 1, the number of nodes 100 is not limited to five. Each node 100 is a device having at least a communication function and an arithmetic processing function, such as a Personal Computer (PC), for example. In the general blockchain technology, each node 100 is assumed to have sufficient performance (specification).

Each node 100 manages a history of transactions in the network as a ledger. When a transaction occurs in one node 100 (for example, the node 100a), calculation (verification) processing is performed in all participating nodes (the nodes 100a to 100e). This provides a mechanism that leaves a correct transaction history that is very difficult to tamper with even when fraud occurs among the participating nodes 100 or the participating node does not operate normally.

Note that the transaction may include, for example, remittance or settlement of money, points, or the like, or occurrence of communication. In this case, the transaction data stored in the blocks of the ledger may be data of remittance or settlement. The transaction data may be communication data. The transaction may include participation or removal of a node in the network. In this case, the transaction data stored in the blocks of the ledger may be data (parameter) of the node 100. The transaction may include an update of the ledger. The transaction data stored in the blocks of the ledger may be data (parameter) of the node 100.

In the embodiment, an example is mainly assumed in which the transaction data stored in the blocks of the ledger is the data (parameter) of the node 100. Management of such data (parameter) of the node 100 with the ledger facilitates guaranteeing that the node 100 in the network is a genuine device.

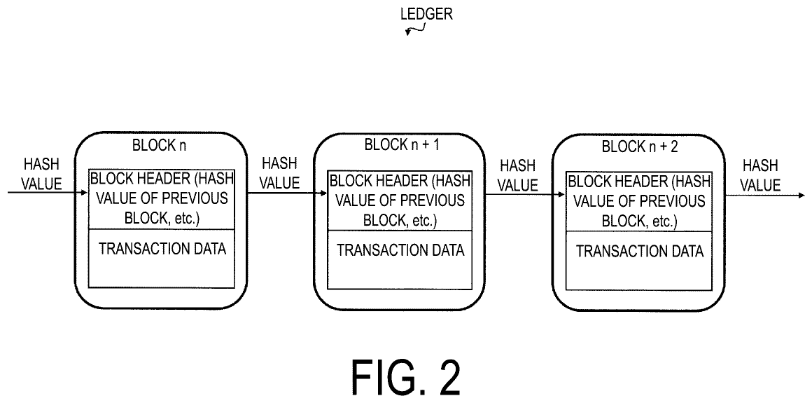

FIG. 2 is a diagram illustrating a configuration example of a ledger managed by each node 100.

Each node 100 stores, in blocks, a record of transactions occurring in the network. One block includes a block header which is a header part and a transaction data part for storing data of at least one transaction. The block header stores a hash value or the like calculated from a block generated immediately before. For example, a block header of a block n+1 stores a hash value calculated from a block n and the like. In this way, the ledger has a data structure in which the generated blocks are connected in a chain form along a time series. The block header may further include a height indicating a corresponding block number and a nonce that is a value used to calculate a hash value.

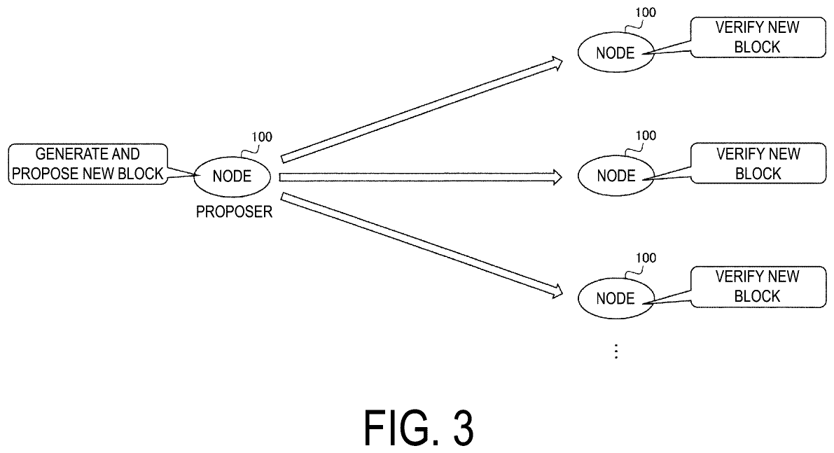

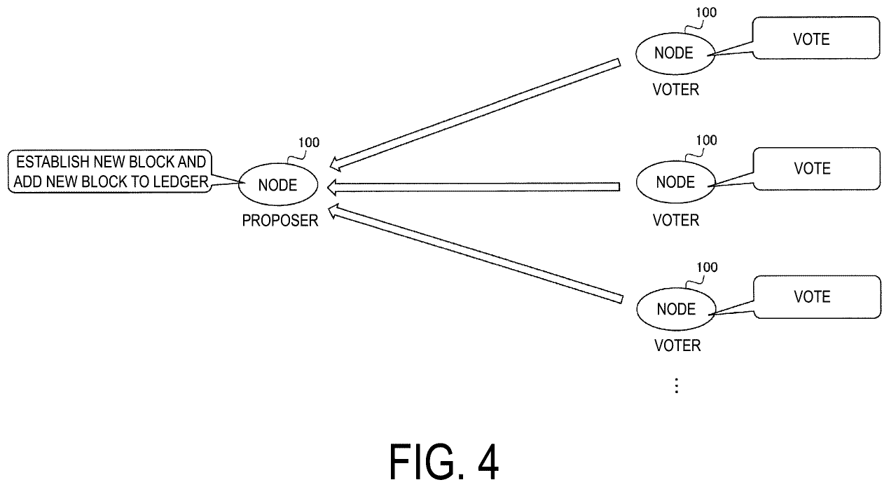

FIG. 3 and FIG. 4 are diagrams illustrating an operation example of operations performed when a new block is added to the ledger (that is, when the ledger is updated).

As illustrated in FIG. 3, after a transaction occurs in a group constituting a P2P network, a node 100 called a “proposer” generates a new block corresponding to the transaction and proposes the new block by notifying the other nodes 100 of the new block. For example, the plurality of nodes 100 calculates a corresponding hash value by using the value of the nonce changed accordingly and the transaction data or the like, and the node 100 (proposer) that finds a hash value satisfying a specific condition notifies the other nodes 100 of a generated block. Upon receiving the proposal of the new block, the other nodes 100 verify the hash value of the new block. Here, the description is given below under assumption that the verification has succeeded.

Subsequently, as illustrated in FIG. 4, the other nodes 100 having received the proposal of the new block vote for the node 100 (proposer) to accept the verified block as the new block. The other nodes 100 that cast a vote are referred to as “voters”. When a certain number of votes are obtained from other nodes 100 (voters), the node 100 (proposer) establishes the proposed new block and adds the new block to the ledger.

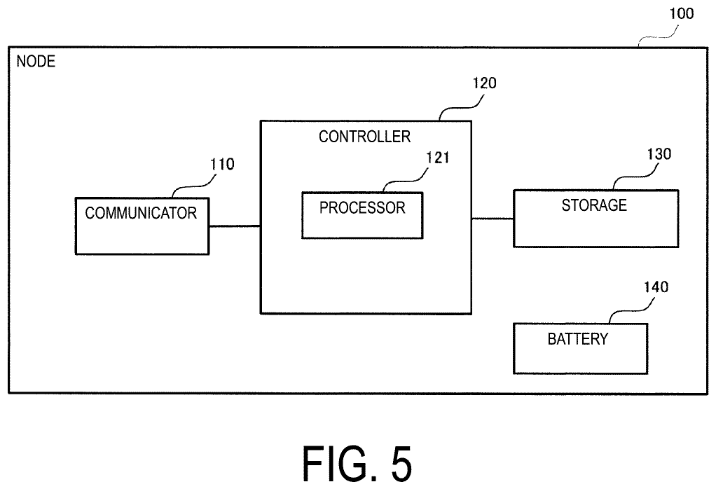

FIG. 5 is a diagram illustrating a configuration example of each node 100.

As illustrated in FIG. 5, the node 100 includes a communicator 110, a controller 120, and a storage 130. The node 100 may include a battery 140.

The communicator 110 includes a communication interface for communicating with another node. The communication interface may be a wireless communication interface or a wired communication interface.

The controller 120 performs various types of control and processing in the node 100. Such processing includes processing described above and processing described later. The controller 120 includes at least one processor 121. The processor 121 executes programs stored in the storage 130 to perform various types of processing.

The storage 130 stores a program to be executed by the processor 121 and information to be used for processing by the processor 121. The storage 130 includes a nonvolatile memory and a volatile memory.

The battery 140 accumulates electrical power to be supplied to portions of the node 100 (device).

### Hierarchically Structured Network

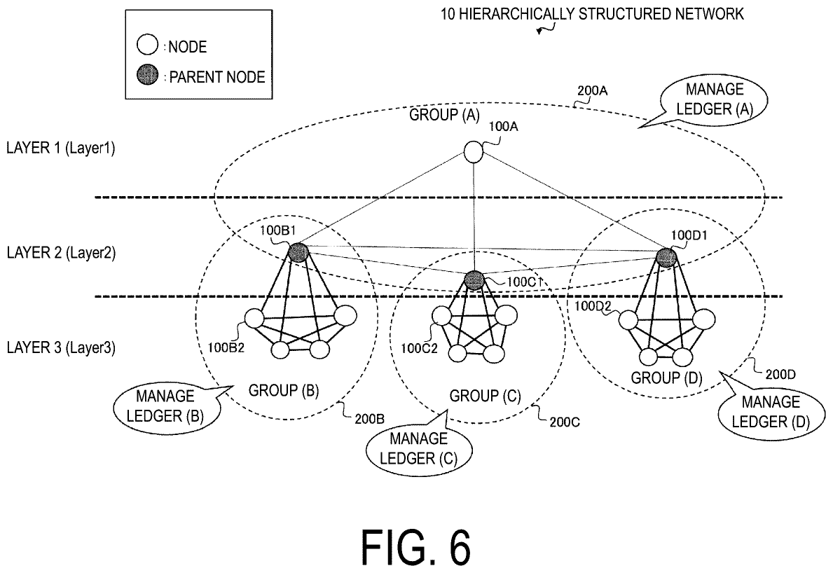

With reference to FIG. 6, the blockchain system according to the embodiment will be described. The blockchain system according to the embodiment includes a network having a hierarchical structure (hereinafter referred to as a “hierarchically structured network”) 10.

As described above, in the blockchain technology, each node 100 is assumed to have sufficient performance, and when a transaction occurs in any one node 100, all of the nodes 100 perform calculation (verification). Therefore, it is difficult to apply the blockchain technology to a device having poor performance such as a small battery capacity, a low calculation capability, or a small storage capacity, for example, an IoT device such as a sensor device.

In the embodiment, the hierarchically structured network 10 is formed, in which each node 100 is located in a layer corresponding to the performance of the node 100. By adopting the hierarchical structure, an upper layer may be a layer with a high calculation frequency (that is, the update frequency of the ledger) and for a lower layer, the calculation frequency may be suppressed. A device having high performance may be located in the upper layer and a device having low performance may be located in the lower layer, which allows the device to participate in the hierarchically structured network 10 of the blockchain independently of whether the device has high performance.

FIG. 6 is a diagram illustrating a configuration example of a network according to the embodiment. In the example of FIG. 6, the hierarchically structured network 10 has a hierarchical structure including three layers of Layer1 to Layer3. Although the embodiment mainly describes an example using three layers, the number of layers may be two, or four or more. In the example illustrated in FIG. 6, Layer1 is the uppermost layer and Layer3 is the lowest layer.

In such a hierarchically structured network 10, each node 100 manages a ledger. Each node 100 is located in a layer corresponding to the performance of the node 100 among the three layers, based on the performance of the node 100. Here, the performance of the node 100 refers to at least one selected from the group consisting of a calculation capability (for example, processor capability), a storage capacity (for example, a memory size), and a battery capacity. The performance of the node 100 may include a sleep time to be described later. For example, when a new node joins, the new node or another node determines a layer in which the new node is to be located, based on the performance of the new node.

Each node 100 located in Layer1 and each node 100 located in Layer2 form an upper layer group. FIG. 6 illustrates an example in which the node 100 belonging to Layer1 is only a node 100A, but a plurality of nodes 100 may be located in Layer1.

The nodes 100 arranged in the Layer2 are three nodes 100B1, 100C1, and 100D1. Each node 100 belonging to a group (A) 200A, which is the upper layer group, manages a ledger (A), which is an upper layer ledger.

Each node 100 located in Layer2 and each node 100 located in Layer3 form a lower layer group that manages lower layer ledgers. For example, a device having high performance is located in Layer1 (or Layer2), and a device having lower performance than the former device is located in Layer3. That is, the node 100 belonging to the lower layer group has lower performance than the node 100 belonging to the upper layer group.

FIG. 6 illustrates an example in which a total of three lower layer groups including groups (B) to (D) are formed. However, the number of lower layer groups is not limited to three, and the number of lower layer groups may be one or four or more.

One node 100B1 located in Layer2 and a plurality of nodes 100B2 located in Layer3 belong to the group (B). Each node 100B belonging to the group (B) manages a ledger (B), which is a lower layer ledger. The node 100B1 belongs to both group (A) and group (B) and manages both ledger (A) and ledger (B). The node 100B1 is a parent node in the group (B). The node 100B2 belongs only to the group (B), and thus manages only the ledger (B).

In the same and/or similar manner, one node 100C1 located in Layer2 and a plurality of nodes 100C2 located in Layer3 belong to the group (C). Each node 100C belonging to the group (C) manages a ledger (C), which is a lower layer ledger. The node 100C1 belongs to both the group (A) and the group (C) and manages both the ledger (A) and the ledger (C). The node 100C1 is a parent node in the group (C). The node 100C2 belongs only to the group (C), and thus manages only the ledger (C).

In the same and/or similar manner, one node 100D1 located in Layer2 and a plurality of nodes 100D2 located in Layer3 belong to the group (D). Each node 100D belonging to the group (D) manages a ledger (D), which is a lower layer ledger. The node 100D1 belongs to both the group (A) and the group (D) and manages both the ledger (A) and the ledger (D). The node 100D1 is a parent node in the group (D). The node 100D2 belongs only to the group (D), and thus manages only the ledger (D).

In each of the groups (A) to (D), the nodes 100 are communicably connected to one another, hold and manage the common ledger within the group, and perform, within the group, processing the same as and/or similar to that in a known blockchain. By such grouping, the number of nodes in each group can be reduced, and thus the increase in size of the ledger can be suppressed.

In general, a node 100 having low performance (for example, an IoT device such as a sensor device) has a lower transaction occurrence frequency than a node 100 having high performance. For example, the node 100 having low performance intermittently performs communication in order to reduce power consumption and enters a sleep state while not performing communication, and no transaction occurs during the sleep time.

In the group (A), which is the upper layer group formed by the nodes 100 having high performance, the ledger (A) may be more frequently updated and more likely to have an increased data amount than in the lower layer group. On the other hand, in the group (B) formed by the nodes 100 having low performance, the update frequency of the ledger (B) can be suppressed and an increase in the data amount of the ledger (B) can be suppressed. In the same and/or similar manner, in the group (C) formed by the nodes 100 having low performance, the update frequency of the ledger (C) can be suppressed and an increase in the data amount of the ledger (C) can be suppressed. In the same and/or similar manner, in the group (D) formed by the nodes 100 having low performance, the update frequency of the ledger (D) can be suppressed and an increase in the data amount of the ledger (D) can be suppressed.

However, although the update frequency and the increase in size of the ledgers can be suppressed by individually managing the ledger for each group, the reliability in the blockchain technology may decrease when the contents of the ledgers of each group and another group are not linked to each other. In the embodiment, the contents of the ledgers between groups can be linked to each other to suppress the update frequency and the increase in size of the ledgers, and suppress the decrease in reliability.

Specifically, the hierarchically structured network 10 includes a plurality of groups including a first group formed by one or more nodes 100 managing a first ledger and a second group formed by one or more nodes 100 managing a second ledger different from the first ledger. In the hierarchically structured network 10, the node(s) 100 belonging to the second group notify the first group of ledger information related to the second ledger. Each node 100 belonging to the first group manages the notified ledger information as a part of the first ledger. This can link the contents of the ledgers between the groups.

Here, the first group is one of the upper layer group or the lower layer group, and the second group is the other of the upper layer group and the lower layer group. That is, the ledgers are linked between groups having a direct communication connection. On the other hand, the ledgers are not linked between lower layer groups, i.e. between groups not having a direct communication connection. This allows the ledgers to be managed independently between the lower layer groups with update of a ledger in one lower layer group not affecting a ledger in another lower layer group.

### Ledger Management Method

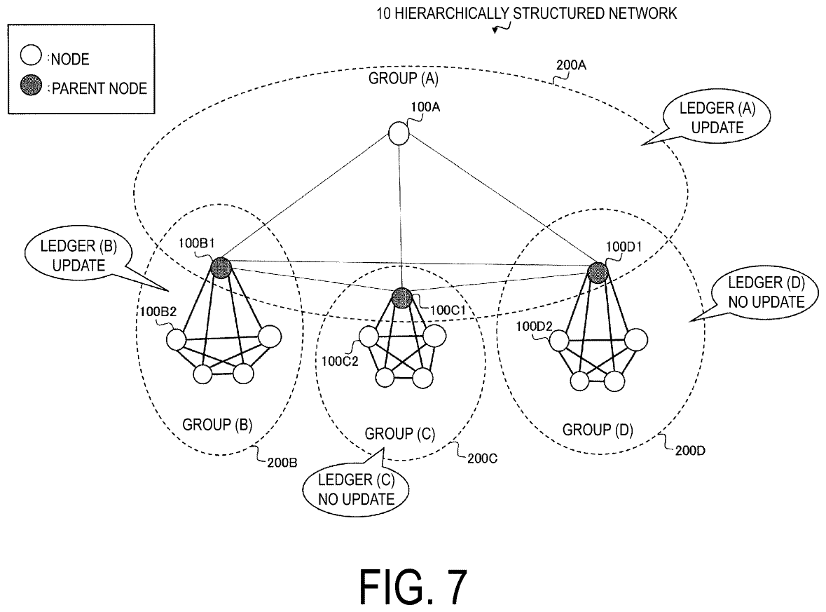

A ledger management method according to the embodiment will be described with reference to FIGS. 7 to 9.

As illustrated in FIG. 7, each node 100 belonging to the upper layer group managing the upper layer ledger updates the upper layer ledger in accordance with each of the transactions in the upper layer group and the transactions in the lower layer group.

For example, the nodes 100 belonging to the group (A) 200A, which is the upper layer group, (nodes 100A, 100B1, 100C1, and 100D1) not only update the ledger (A), which is the upper layer ledger, in accordance with transactions in the group (A) 200A, but also update the ledger (A) in accordance with transactions in any of the lower layer groups (group (B) 200B, group (C) 200C, or group (D) 200D). FIG. 7 illustrates an example in which the nodes 100 belonging to the group (A) 200A (nodes 100A, 100B1, 100C1, and 100D1) update the ledger (A) in response to the ledger (B) in the group (B) 200B being updated.

The update frequency of the upper layer ledger in the upper layer group is the same as and/or similar to the update frequency of the ledger in the general hierarchically structured network 10 (see FIG. 1) having no hierarchical structure. The transactions in the lower layer groups (group (B) 200B, group (C) 200C, and group (D) 200D) are reflected on the ledger (A), which is the upper layer ledger, and the reliability of the blockchain technology can thus be maintained.

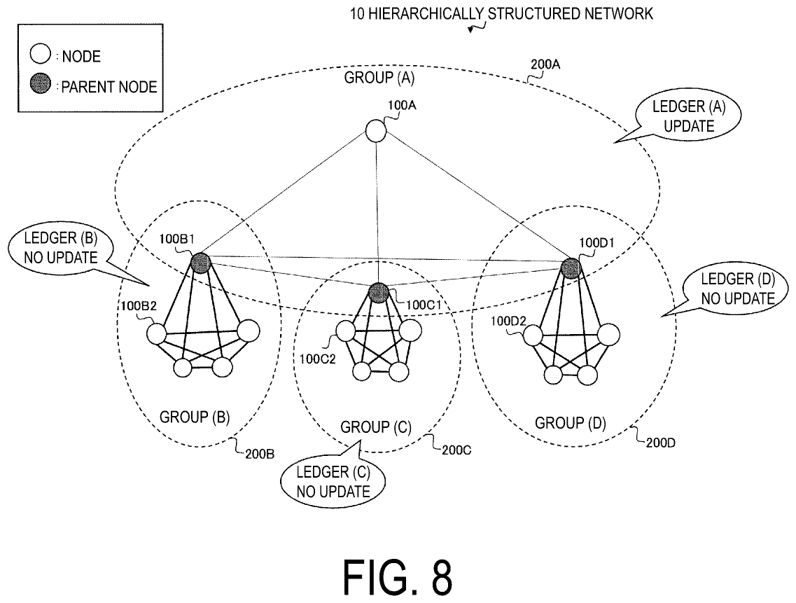

On the other hand, as illustrated in FIG. 8, the nodes 100 belonging to the lower layer group managing the lower layer ledgers update, instead of updating the lower layer ledgers in accordance with the transactions in the upper layer group, the lower layer ledgers in accordance with the transactions in the lower layer groups. That is, even when the upper layer ledger is updated, the lower layer ledgers are not updated. This can reduce the update frequency of the lower layer ledgers in the lower layer groups.

For example, the nodes 100B belonging to the group (B) 200B, which is the lower layer group, (nodes 100B1 and 100B2) update the ledger (B), which is the lower layer ledger, in accordance with transactions in the group (B) 200B, but do not update the ledger (B) in accordance with the transactions in the group (A) 200A. In the same and/or similar manner, the nodes 100C belonging to the group (C) 200C, which is the lower layer group, (nodes 100C1 and 100C2) update the ledger (C), which is the lower layer ledger, in accordance with transactions in the group (C) 200C, but do not update the ledger (C) in accordance with the transactions in the group (A) 200A. In the same and/or similar manner, the nodes 100D belonging to the group (D) 200D, which is the lower layer group, (nodes 100D1 and 100D2) update the ledger (D), which is the lower layer ledger, in accordance with transactions in the group (D) 200D, but do not update the ledger (D) in accordance with the transactions in the group (A) 200A.

As illustrated in FIG. 7, each node 100 belonging to the lower layer group managing the lower layer ledger does not update the lower layer ledger in accordance with transactions in the other lower layer groups. For example, even when the ledger (B) is updated in the group (B) 200B, which is the lower layer group, the group (C) 200C and the group (D) 200D, which are other lower layer groups, do not update the ledger (C) and the ledger (D). This can reduce the update frequency of the lower layer ledgers in the lower layer groups.

As described above, when a transaction occurs in a lower layer group, the upper layer ledger is updated in the upper layer group, but the ledgers do not need to be updated in the other lower layer groups. Even when a transaction occurs in the upper layer group, the lower layer ledgers in the lower layer groups do not need to be updated. This can reduce the whole amount of calculation. Therefore, the blockchain technology can be applied even to a device having a low calculation processing capability and/or a small memory capacity.

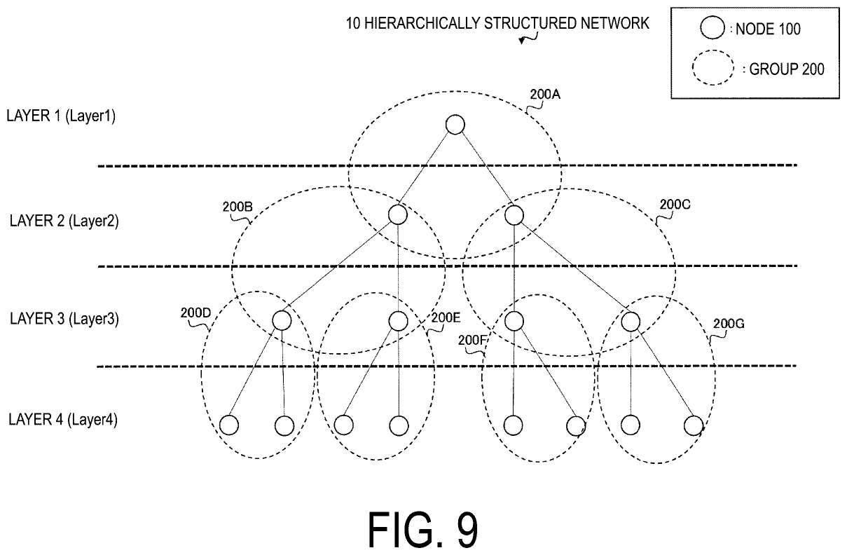

FIG. 9 is a diagram for describing an effect of reducing the amount of calculation when the hierarchically structured network 10 according to the embodiment is compared with a general network configuration (see FIG. 1). Here, an example of adopting a hierarchical structure of a binary tree is illustrated. It is assumed that n (n≥4) nodes 100 are present and the transaction occurrence frequencies in the respective nodes 100 are equivalent to one another.

As illustrated in FIG. 9, the node 100 in the uppermost layer (Layer1) is required to calculate transactions of all nodes, and thus has the calculation frequency the same as that in the general blockchain technology. On the other hand, each node 100 in the lowest layer is required to perform calculation only for transactions of the group in which the node 100 itself participates. In the case of the binary tree, the number of nodes in each group is 3, and thus the calculation frequency can be suppressed to 3/n.

For example, when layers other than the uppermost layer have a two-layer structure (n=7), the calculation can be reduced by about 38% of the total. When the layers other than the uppermost layer have a three-layer structure (n=15), the calculation can be reduced by about 61% of the total. When n is large enough (limit−>) , the calculation can be reduced by about 67% of the total. Specifically, the lower the layer, the more the calculation frequency can be reduced. Therefore, the amount of communication and the number of times of calculation can be suppressed as compared with those in the general blockchain technology. Thus, even a device having insufficient performance for participation in a case of using the general blockchain technology can utilize the blockchain technology.

Note that in the network configuration illustrated in FIG. 9, the upper layer group and the lower layer group are configured between each two groups having a direct communication connection. For example, based on the group 200B, the group 200A is the upper layer group, and each of the group 200D and the group 200E is the lower layer group. Based on the group 200D and the group 200E, the group 200B is the upper layer group. In the same and/or similar manner, based on the group 200C, the group 200A is the upper layer group, and each of the group 200F and the group 200G is the lower layer group. Based on the group 200F and the group 200G, the group 200C is the upper layer group.

### Link between Upper Hierarchy Ledger and Lower Hierarchy Ledger

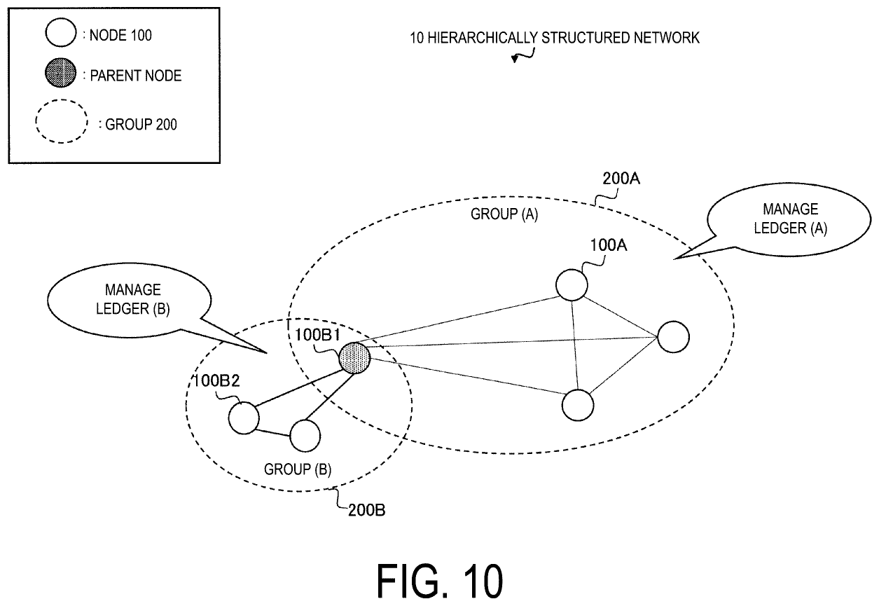

With reference to FIGS. 10 to 13, the link between the upper layer ledger and the lower layer ledger according to the embodiment will be described.

As illustrated in FIG. 10, the hierarchically structured network 10 is configured by the group (A) 200A formed by the nodes 100 (nodes 100A and 100B1) managing the ledger (A) and the group (B) 200B formed by the nodes 100 (nodes 100B1 and 100B2) managing the ledger (B).

The node 100 belonging to the group (A) 200A notifies the group (B) 200B of the ledger information related to the ledger (A). For example, the node 100B1 belonging to the group (A) 200A notifies another node 100B2 in the group (B) 200B of the ledger information related to the ledger (A). Each node 100 belonging to the group (B) 200B (nodes 100B1 and 100B2) manages the ledger information as a part of the ledger (B). In this way, each node 100 belonging to the lower layer group managing the lower layer ledger manages the ledger information related to the upper layer ledger as a part of the lower layer ledger. This allows the lower layer ledger to be linked to the upper layer ledger.

For example, the ledger information managed as a part of the ledger (B), which is the lower layer ledger, may include a chain ID indicating the ledger (A), which is the upper layer ledger. The ledger information managed as a part of the ledger (B) may include a hash value calculated from a block of the ledger (A). The ledger information managed as a part of the ledger (B) may include a block height indicating a block number of the ledger (A). Here, each node 100 belonging to the group (B) (nodes 100B1 and 100B2) may store the ledger information in a header part (block header) of a block of the ledger (B). This facilitates identification of the ledger (A) and a search for which block of the ledger (A) is linked to at the time of verification in the group (B) 200B, and also facilitates transmission of information such as a verification result from the group (B) 200B to the group (A) 200A.

On the other hand, each node 100 belonging to the group (B) 200B notifies the group (A) 200A of the ledger information related to the ledger (B). For example, the node 100B1 belonging to the group (B) 200B notifies another node 100A in the group (A) 200A of the ledger information related to the ledger (B). Each node 100 belonging to the group (A) 200A (nodes 100B1 and 100A) manages the ledger information as a part of the ledger (A). In this way, each node 100 belonging to the upper layer group managing the upper layer ledger manages the ledger information related to the lower layer ledger as a part of the upper layer ledger. This allows the upper layer ledger to be linked to the lower layer ledger.

For example, the ledger information managed as a part of the ledger (A), which is the upper layer ledger, may include a chain ID indicating the ledger (B), which is the lower layer ledger. The ledger information managed as a part of the ledger (A) may include a hash value calculated from a block of the ledger (B). The ledger information managed as a part of the ledger (A) may include a block height indicating a block number of the ledger (B). Here, each node 100 belonging to the group (A) (nodes 100B1 and 100A) may store the ledger information in a transaction data part of a block of the ledger (A). As a result, the ledger (B), even having a low update frequency and having a length not long enough, is associated with the sufficiently long ledger (A), so that a decrease in a strength of security can be suppressed. For example, fork protection of the ledger (B) can be easily confirmed at the time of verification in the group (A) 200A. That is, a wrong (fake) blockchain is not branched, and a correct ledger (B) can be easy to confirm.

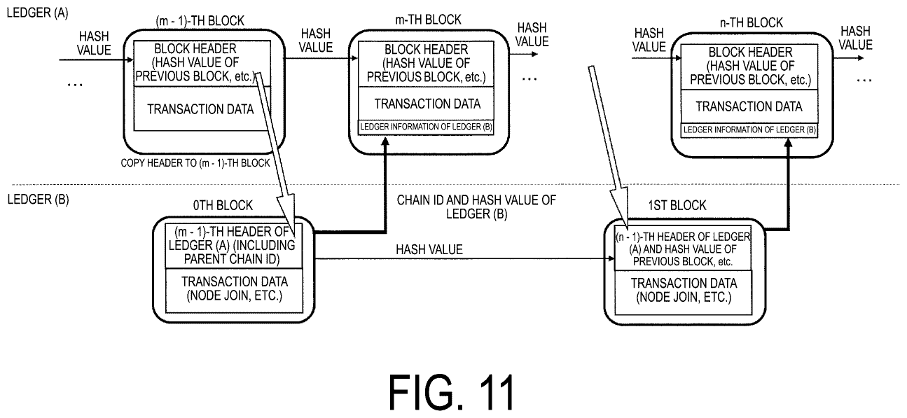

FIG. 11 is a diagram illustrating an operation example of operations performed when the group (A) 200A is formed and subsequently the group (B) 200B is newly formed below the group (A) 200A. Here, a node belonging to the group (A) 200A is referred to as a node (A), and a node belonging to the group (B) 200B is referred to as a node (B). However, since the parent node belongs to both the group (A) 200A and the group (B) 200B, the operations in FIG. 11 may be performed in the same node (parent node).

As illustrated in FIG. 11, first, the node (A) managing the ledger (A) updates the ledger (A) by adding the (m−1)-th block to the ledger (A). The (m−1)-th block includes a block header including a hash value calculated from the previous block of the ledger (A) and transaction data for at least one transaction in the group (A) 200A. The block header may further include a chain ID (parent chain ID) indicating the ledger (A) and/or a block height indicating (m−1), which is a block number of the block.

Second, the group (B) 200B is formed. The node (B) managing the ledger (B) updates (generates) the ledger (B) by adding the first block in the ledger (B), that is, the 0-th block to the ledger (B). The 0-th block includes in a block header part thereof a block header of a block of the ledger (A) which is the latest at the time when the 0-th block is added, that is, a block header of the (m−1)-th block of the ledger (A) as the ledger information related to the ledger (A). The 0-th block also includes in a transaction data part thereof transaction data for at least one transaction in the group (B) 200B. Here, the transaction may be, for example, node join in the group (B) 200B. The transaction data may include a node parameter for the joined node.

Third, the node (A) managing the ledger (A) updates the ledger (A) by adding the m-th block to the ledger (A). The m-th block includes in a block header part thereof a hash value calculated from the (m−1)-th block, which is the previous block of the ledger (A). The m-th block also includes in a transaction data part thereof transaction data for at least one transaction in the group (A) 200A and ledger information related to the ledger (B). The ledger information includes a hash value calculated from a block of the ledger (B) which is the latest at the time when the m-th block is added, that is, the 0-th block of the ledger (B), and a chain ID indicating the ledger (B). The ledger information may further include a block height indicating 0, which is a block number of the 0-th block.

Fourth, the node (B) managing the ledger (B) updates the ledger (B) by adding the 1st block in the ledger (B) to the ledger (B). The 1st block includes in a block header part thereof a block header of a block of the ledger (A) which is the latest at the time when the 1st block is added, as the ledger information related to the ledger (A). The 1st block includes in the block header part thereof a hash value calculated from the 0-th block of the ledger (B). The 1st block also includes in a transaction data part thereof transaction data for at least one transaction in the group (B) 200B. Here, the transaction may be, for example, node join in the group (B) 200B. The transaction data may include a node parameter for the joined node.

Fifth, the node (A) managing the ledger (A) updates the ledger (A) by adding the n-th block to the ledger (A). The n-th block includes in a block header part thereof a hash value calculated from the (n−1)-th block, which is the previous block of the ledger (A). The n-th block also includes in a transaction data part thereof transaction data for at least one transaction in the group (A) 200A and ledger information related to the ledger (B). The ledger information includes a hash value calculated from a block of the ledger (B) which is the latest at the time when the n-th block is added, that is, the 1st block of the ledger (B), and a chain ID indicating the ledger (B). The ledger information may further include a block height indicating 1, which is a block number of the 1st block.

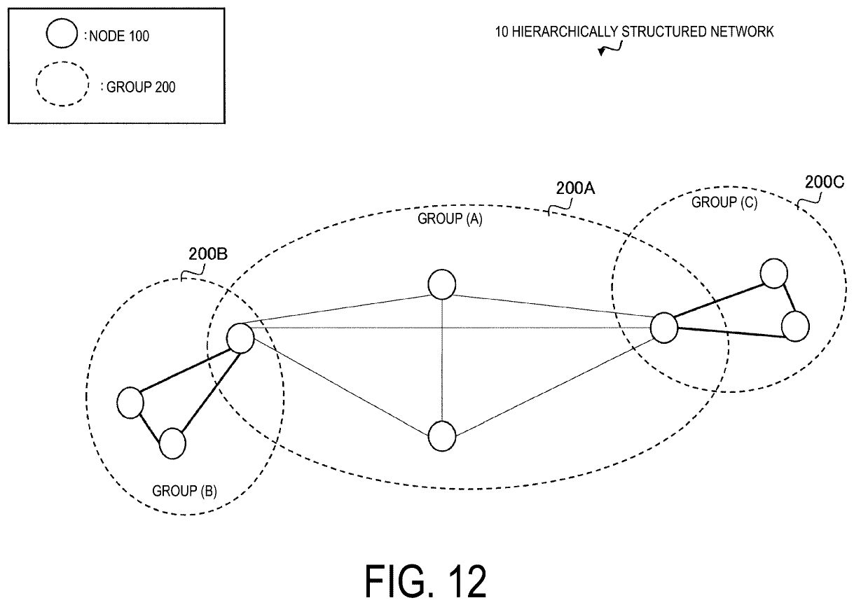

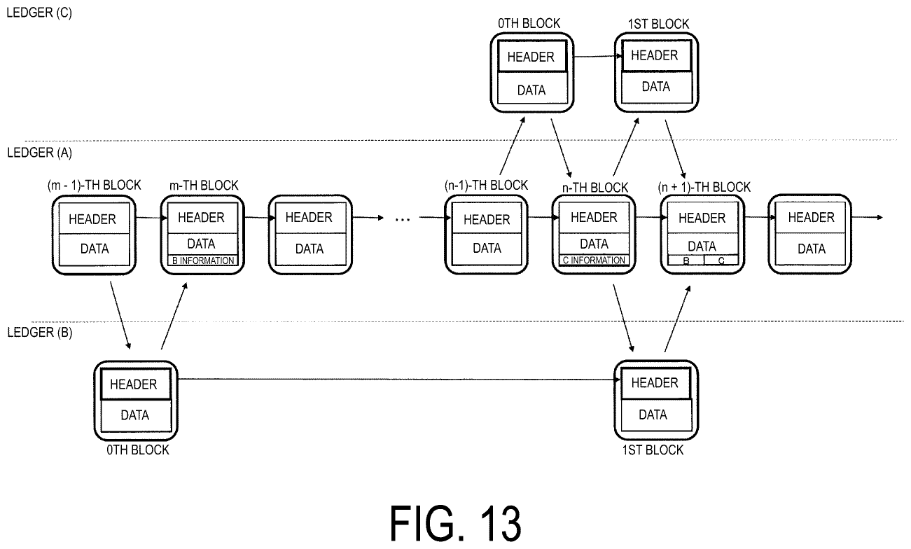

FIG. 12 and FIG. 13 are diagrams illustrating an operation example of operations performed when the group (A) 200A is formed and subsequently the group (B) 200B is newly formed below the group (A) 200A, and further subsequently the group (C) 200C is newly formed below the group (A) 200A. Here, a node belonging to the group (A) 200A is referred to as the node (A), a node belonging to the group (B) 200B is referred to as the node (B), and a node belonging to the group (C) 200C is referred to as the node (C). Here, differences from the operations in FIG. 11 are mainly described.

As illustrated in FIG. 13, first, the node (A) managing the ledger (A) updates the ledger (A) by adding the (m−1)-th block to the ledger (A). Second, the group (B) 200B is formed. The node (B) managing the ledger (B) updates (generates) the ledger (B) by adding the first block in the ledger (B), that is, the 0-th block to the ledger (B). Third, the node (A) managing the ledger (A) updates the ledger (A) by adding the m-th block to the ledger (A). Such operations are the same as and/or similar to those in FIG. 11.

Fourth, the node (A) managing the ledger (A) updates the ledger (A) by adding the (n−1)-th block to the ledger (A). The (n−1)-th block includes a block header including a hash value calculated from the previous block of the ledger (A) and transaction data for at least one transaction in the group (A) 200A. The block header may further include a chain ID (parent chain ID) indicating the ledger (A) and/or a block height indicating (n−1), which is a block number of the block.

Fifth, the group (C) 200C is formed. The node (C) managing the ledger (C) updates (generates) the ledger (C) by adding an initial block in the ledger (C), that is, the 0-th block to the ledger (C). The 0-th block includes in a block header part thereof a block header of a block of the ledger (A) which is the latest at the time when the 0-th block is added, that is, a block header of the (n−1)-th block of the ledger (A) as the ledger information related to the ledger (A). The 0-th block also includes in a transaction data part thereof transaction data for at least one transaction in the group (C) 200C. Here, the transaction may be, for example, node join in the group (C) 200C. The transaction data may include a node parameter for the joined node.

Sixth, the node (A) managing the ledger (A) updates the ledger (A) by adding the n-th block to the ledger (A). The n-th block includes in a block header part thereof a hash value calculated from the (n−1)-th block, which is the previous block of the ledger (A). The n-th block also includes in a transaction data part thereof transaction data for at least one transaction in the group (A) 200A and ledger information related to the ledger (C). The ledger information includes a hash value calculated from a block of the ledger (C) which is the latest at the time when the n-th block is added, that is, the 0-th block of the ledger (C), and a chain ID indicating the ledger (C). The ledger information may further include a block height indicating 0, which is a block number of the 0-th block.

Seventh, the node (C) managing the ledger (C) updates the ledger (C) by adding the 1st block in the ledger (C) to the ledger (C). The 1st block includes in a block header part thereof a block header of a block of the ledger (A) which is the latest at the time when the 1st block is added, that is, a block header of the n-th block of the ledger (A) as the ledger information related to the ledger (A). The 1st block also includes in a transaction data part thereof transaction data for at least one transaction in the group (C) 200C. Here, the transaction may be, for example, node join in the group (C) 200C. The transaction data may include a node parameter for the joined node.

Eighth, the node (B) managing the ledger (B) updates the ledger (B) by adding the 1st block in the ledger (B) to the ledger (B). The 1st block includes in a block header part thereof a block header of a block of the ledger (A) which is the latest at the time when the 1st block is added, that is, a block header of the n-th block of the ledger (A) as the ledger information related to the ledger (A). The 1st block also includes in a transaction data part thereof transaction data for at least one transaction in the group (B) 200B. Here, the transaction may be, for example, node join in the group (B) 200B. The transaction data may include a node parameter for the joined node.

Ninth, the node (A) managing the ledger (A) updates the ledger (A) by adding the (n+1)-th block to the ledger (A). The (n+1)-th block includes in a block header part thereof a hash value calculated from the n-th block, which is the previous block of the ledger (A). The (n+1)-th block also includes in a transaction data part thereof transaction data for at least one transaction in the group (A) 200A, ledger information related to the ledger (B), and ledger information related to the ledger (C). The ledger information related to the ledger (B) includes a hash value calculated from a block of the ledger (B) which is the latest at the time when the (n+1)-th block is added, that is, the 1st block of the ledger (B), and a chain ID indicating the ledger (B). The ledger information may further include a block height indicating 0, which is a block number of the 1st block of the ledger (B). The ledger information related to the ledger (C) includes a hash value calculated from a block of the ledger (C) which is the latest at the time when the (n+1)-th block is added, that is, the 1st block of the ledger (C), and a chain ID indicating the ledger (C). The ledger information may further include a block height indicating 0, which is a block number of the 1st block of the ledger (C).

### Grouping of Lower Layer Groups

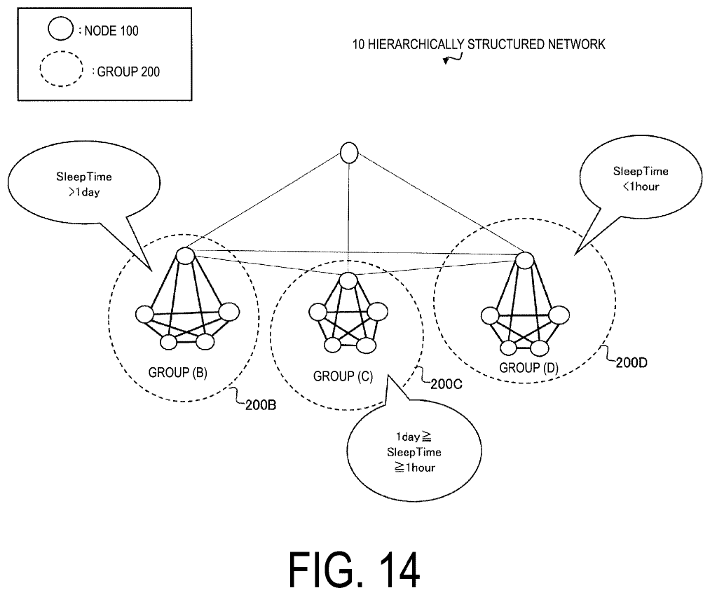

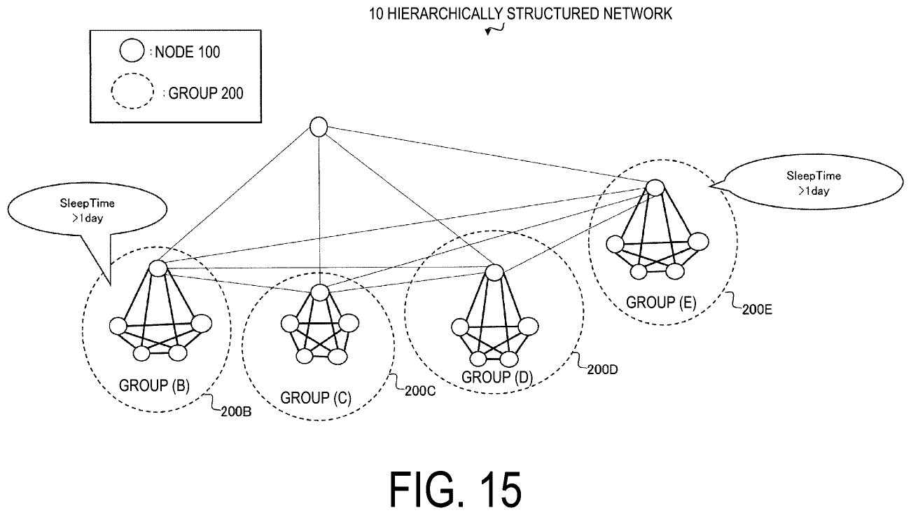

Grouping of the lower layer groups according to the embodiment will be described with reference to FIG. 14 and FIG. 15.

As illustrated in FIG. 14, the hierarchically structured network 10 includes a plurality of lower layer groups, the group (B) 200B to the group (D) 200D. Each of the nodes 100 belonging to the plurality of lower layer groups is located in one of the plurality of lower layer groups in accordance with a length of the sleep time of the node 100. As described above, a low-performance node such as an IoT device intermittently performs communication in order to reduce power consumption and enters a sleep state (standby state) while not performing communication, and no transaction occurs during the sleep time (standby time). For the second and subsequent lower layers, by performing grouping based on a range of the sleep time, grouping into a group having a long sleep time and a group having a short sleep time can be performed.

Specifically, devices having sleep times close to each other are grouped into the same group. A device having a long sleep time has a low transaction occurrence frequency, and thus has a low calculation frequency, so that the calculation frequency can be reduced. Here, since many devices having long sleep times have low performance, the relevant grouping is effective. In this way, grouping nodes in consideration of the transaction occurrence frequency can suppress an increase in size of the ledgers while suppressing the calculation amount.

The sleep time of each node 100 belonging to one lower layer group among the plurality of lower layer groups may be within a range of a first predetermined time. The sleep time of each node 100 belonging to another lower layer group different from the one lower layer group may be within a range of a second predetermined time different from the first predetermined time. In the example of FIG. 14, each node 100 belonging to the group (B) 200B has a sleep time longer than one day. Each node 100 belonging to the group (C) 200C has a sleep time of one day or shorter and one hour or longer. Each node 100 belonging to the group (D) 200D has a sleep time shorter than one hour. Note that such grouping is an example and the grouping is not limited to the example of FIG. 14.

The maximum number of nodes 100 belonging to each group may be determined in accordance with the performance of the nodes 100 belonging to the group. For example, the limitation of the number of nodes in one group may be determined depending on the node having the lowest performance among the nodes participating in the group. As the number of nodes in one group increases, the update frequency and the size of the ledger tend to increase. Therefore, according to the performance of the node having the lowest performance, the maximum number for the group to which the node belongs is determined.

As illustrated in FIG. 15, when the number of nodes 100 belonging to a lower layer group exceeds the maximum number of nodes 100 belonging to the lower layer group, a new lower layer group may be formed. FIG. 15 illustrates an example in which a new group (E) 200E including nodes 100 each having a sleep time longer than one day is formed when the number of nodes 100 each having a sleep time longer than one day exceeds the maximum number (limit number) of the group (B) 200B. In this way, when the number of nodes is equal to or longer than the limit number, a group in the same rage of sleep time is newly added. When the number of nodes 100 belonging to a lower layer group exceeds the maximum number of nodes 100 belonging to the lower layer group, a lower layer may be added to form a further lower group.

### Priority in Group

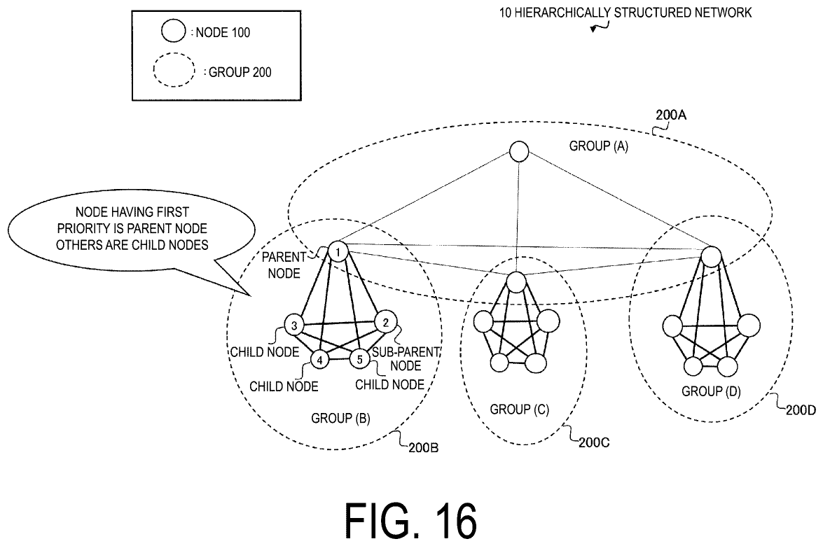

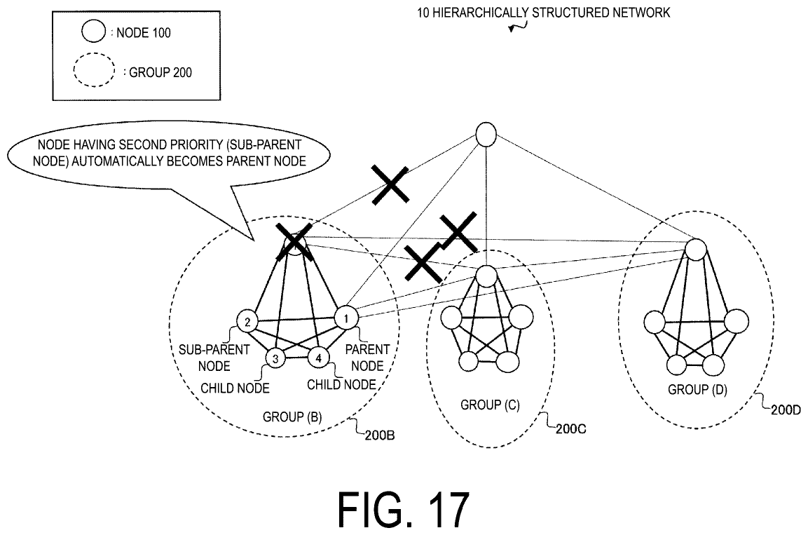

A priority in a group according to the embodiment will be described with reference to FIG. 16 and FIG. 17.

As illustrated in FIG. 16, performance parameters are used to prioritize the nodes in each group. The priority is calculated based on at least one selected from the group consisting of a battery capacity, a calculation capability, a storage capacity, and a sleep time, which are the performance parameters. In one group, a node having the first priority is set as a parent node, a node having the second priority is set as a sub-parent node, and the other nodes are set as child nodes. In FIG. 16, the priorities of the nodes 100 in the group (B) 200B, which is a lower layer group, are indicated by numerals. For example, when a new node 100 joins the lower layer group, the new node 100 or another node 100 determines whether to set the new node 100 as a parent node, a sub-parent node, or a child node, based on the performance of the new node 100.

The plurality of nodes 100 forming one group include the parent node that belongs to both the upper layer group and the lower layer group and manages the lower layer ledger and the upper layer ledger, the sub-parent node that belongs to the lower layer group and when the parent node no longer functions as the parent node, is changed to a new parent node, and the child node 100 that belongs to the lower layer group and corresponds to neither the parent node 100 nor the sub-parent node 100.

Here, the sub-parent node 100 has higher performance than the child node 100, and the parent node 100 has higher performance than the sub-parent node 100. The sub-parent node 100 plays more roles than the child node 100, and the parent node 100 plays more roles than the sub-parent node 100. Therefore, the roles played by the node 100 are matched with the performance the node 100.

For example, when a transaction occurs in the lower layer group and the lower layer ledger is updated, the parent node notifies the upper layer group that the lower layer ledger has been updated. As a result, a transaction occurs in the upper layer group (the upper layer ledger is updated). Specifically, the parent node notifies the node 100 belonging to the upper layer group of the update of the lower layer ledger in accordance with the transaction in the lower layer group, and the node 100 belonging to the upper layer group updates the upper layer ledger in accordance with the notification from the parent node.

When the upper layer ledger of the upper layer group is updated, the parent node passes the upper layer ledger to the sub-parent node. That is, when the upper layer ledger is updated, the parent node shares the updated upper layer ledger with the sub-parent node.

In the example of FIG. 16, when a transaction occurs in the group (B) 200B and the ledger (B) is updated, the parent node in the group (B) 200B notifies the group (A) 200A that the ledger (B) has been updated. This causes a transaction to occur in the group (A) 200A (the ledger (A) is updated). When the ledger (A) in the group (A) 200A is updated, the parent node in the group (B) 200B passes the ledger (A) to the sub-parent node in the group (B) 200B.

As illustrated in FIG. 17, when the parent node is removed from the group for some reason (for example, the parent node itself leaves the group, or is forced to be removed due to fraud, etc.), the sub-parent node having the second priority automatically receives the first priority, that is, becomes a new parent node. The priorities of the other nodes are also raised by one. When the sub-parent node is changed to a new parent node or when the sub-parent node no longer functions as the sub-parent node, the child node having the highest priority among the plurality of child nodes is changed to a new sub-parent node. Note that since the priorities need to be associated with each corresponding group, each node 100 has a parameter value of the priority associated with the chain ID.

The node 100 initially set as the parent node has no problem because the node 100 is selected based on the performance parameter, but the new parent node set based on the raise because of the parent node removal may be insufficient in the performance parameter. For this reason, a threshold value may be set for the performance parameters of each layer, and the parent node having the performance parameter lower than the threshold value may be changed (rotated) every predetermined number of transactions. That is, when, in response to the removal of the parent node, the sub-parent node is set as a new parent node and the performance of the new parent node does not satisfy a predetermined criterion, the node 100 set as the parent node may be changed every predetermined number of transactions. At the time of the change, the priority of the parent node is set to the lowest in the group, and the sub-parent node becomes the next parent node. The number of transactions for rotating the parent node is held as a node parameter and can be changed.

### Example of Node Parameters Stored in Ledgers

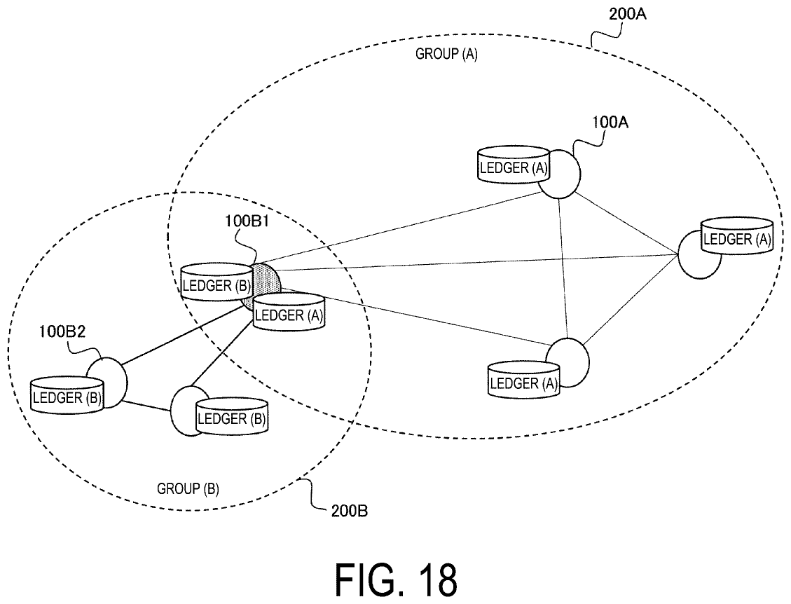

An example of the node parameters stored in the ledgers according to the embodiment will be described with reference to FIG. 18.

As described above, in the embodiment, the node parameter may be stored in the ledger. For example, when a new node 100 joins the upper layer group, each node 100 belonging to the upper layer group may update the upper layer ledger to add a parameter of the new node 100 that has joined the upper layer group to the upper layer ledger. When a new node 100 joins the lower layer group, each node 100 belonging to the lower layer group may update the lower layer ledger to add a parameter of the new node 100 that has joined the lower layer group to the lower layer ledger.

As illustrated in FIG. 18, the node 100 other than the node 100A in the uppermost layer and the node 100B2 in the lowest layer, that is, the node 100B1 belongs to two groups. Therefore, the node 100B1, which needs to hold a common ledger for each group, includes two ledgers (ledger (A) and ledger (B)). Here, each of the two groups (group (A) and group (B)) has a parameter to be distinguished in a form associated with a chain ID. As described above, the ledger (A), which is the upper layer ledger, includes the hash value and the like of the ledger (B), which is the lower layer ledger. Hence, when the ledger (B) is updated, the ledger (A) also needs to be updated.

An example of the node parameters stored in the ledgers is at least one selected from the group consisting of the following parameters.
Chain ID: Up to two are required. The chain ID makes it possible to determine which of two groups is the upper layer group.
Hash value of corresponding ledger: This is a value associated with a chain ID, and up to two are required.
Node priority: This is a value associated with a chain ID, and up to two are required.
Parent chain ID: A chain ID of the upper layer in which the parent node in the group participates. The hierarchical structure can be smoothly automated by clarifying the parent-child relationship of the groups.
Validator Node ID: An ID of the node proving that the corresponding ledger is correct.
Parent node rotation value: The number of transactions that cause the parent node rotation. When the number of parent node transactions reaches this value, rotation of the parent node occurs.
The number of parent node transactions: The number of transactions occurring after becoming the parent node.
Performance parameter of node: For example, the performance parameter is at least one selected from the group consisting of a battery capacity, a calculation capability, a storage capacity (memory margin information), and a sleep time.

### Locking of Ledger

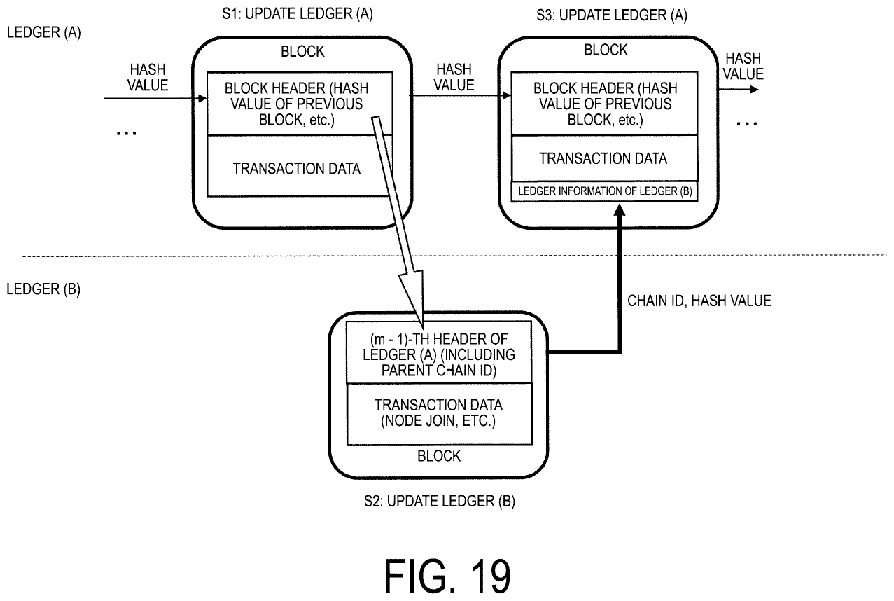

Locking of the ledger according to the embodiment will be described with reference to FIGS. 19 to 24.

As described above, by configuring the hierarchically structured network 10, a low-spec device can participate in the blockchain as a node. In the embodiment, when the lower layer ledger of the lower layer group is updated, first, the information of the upper layer ledger is included in the lower layer ledger to update the lower layer ledger, and second, the information of the updated lower layer ledger is included in the upper layer ledger to update the upper layer ledger, thus linking the upper layer ledger and the lower layer ledger (see FIG. 11). That is, in the embodiment, the upper layer ledgers and the lower layer ledgers are linked in chronological order by repeating the operations of steps S1 to S3 illustrated in FIG. 19.

Specifically, as illustrated in FIG. 19, in step S1, the node (A) belonging to the group (A) 200A managing the ledger (A), which is the upper layer ledger, updates the ledger (A) by adding a new block to the ledger (A). The new block includes a block header including a hash value calculated from the previous block of the ledger (A) and transaction data for at least one transaction in the group (A) 200A.

In step S2, the node (B) belonging to the group (B) 200B managing the ledger (B), which is a lower layer ledger, updates the ledger (B) by adding a new block to the ledger (B). The new block includes in a block header part thereof a block header of a block of the ledger (A) which is the latest at the time when the new block is added, as the ledger information related to the ledger (A), and includes in a transaction data part of the new block transaction data related to at least one transaction in the group (B) 200B.

In step S3, the node (A) belonging to the group (A) 200A managing the ledger (A) updates the ledger (A) by adding a new block to the ledger (A). The new block includes in a block header part thereof a hash value calculated from the previous block of the ledger (A), and includes in a transaction data part of the new block transaction data for at least one transaction in the group (A) 200A and ledger information related to the ledger (B). The ledger information includes a hash value calculated from a block of the ledger (B) which is the latest at the time when a block is added, and a chain ID indicating the ledger (B). The ledger information may further include a block height that is a block number of the block added to the ledger (B).

As described above, after a new block is added to the ledger (B) in step S2, information of the added new block needs to be written to a new block of the ledger (A) in step S3. However, when step S2 occurs after step S3, that is, when the completion of the update processing for the ledger (B) is not in time for the update timing for the ledger (A), the ledger (A) and the ledger (B) cannot be linked in chronological order. In this case, the group (A) 200B cannot be used at the time of verification in the group (B) 200A, and an insufficient length of the ledger (B) causes security to fail to be guaranteed.

In the embodiment, such a problem is solved by refraining from updating the ledger (that is, locking the ledger) for a predetermined period (hereinafter, referred to as a “lock period”) after updating the ledger. That is, in the embodiment, the node 100 belonging to a first group (upper layer group) of a first layer different from the lowest layer manages a first ledger (upper layer ledger) including transaction data related to a transaction in the first group, and performs ledger locking to refrain from updating the first ledger over a lock period after the first ledger is updated. If the second ledger (lower layer ledger) managed by the second group (lower layer group) of the second layer lower than the first layer has been updated within the lock period when the lock period ends (i.e., upon unlocking), the node 100 updates the first ledger to include, in the first ledger, the ledger information related to the updated second ledger.

In this way, locking the upper layer ledger over the lock period facilitates avoiding failure in the completion of the update processing for the lower layer ledger in time for the update timing of the upper layer ledger, and also facilitates linking the upper layer ledger and the lower layer ledger in chronological order. As a result, the upper hierarchical group is easily utilized at the time of verification in the lower hierarchical group, and security is easily guaranteed in spite of an insufficient length of the lower hierarchical ledger. Note that although an example will be described below in which the first group is the group (A) 200A and the second group is the group (B) 200B, the first group may be the group (B) 200B and the second group may be a group in a layer lower than the layer of the group (B) 200B.

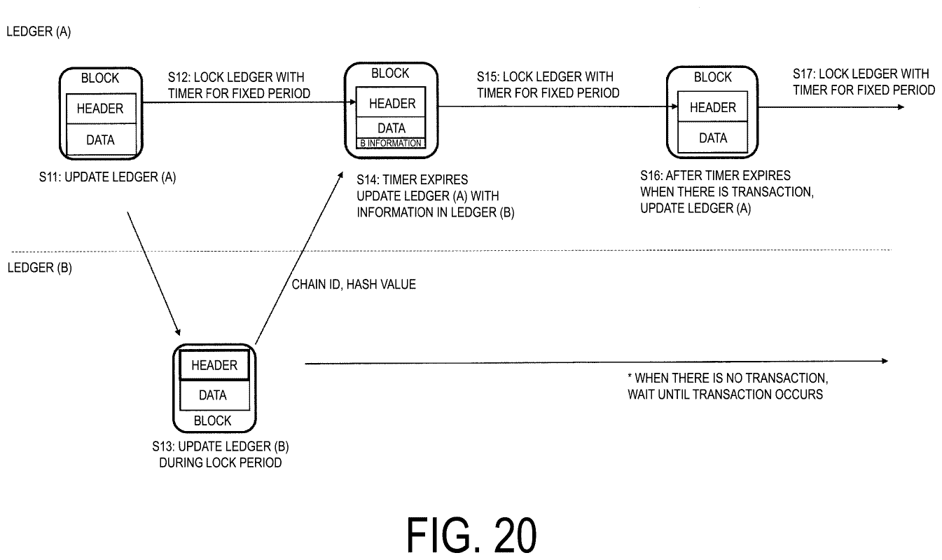

FIG. 20 is a diagram for illustrating a lock operation for ledger update according to the embodiment.

As illustrated in FIG. 20, in step S11, the node (A) belonging to the group (A) 200A updates the ledger (A) by adding a new block to the ledger (A). The new block includes a block header including a hash value calculated from the previous block of the ledger (A) and transaction data for at least one transaction in the group (A) 200A.

In step S12, the node (A) belonging to the group (A) 200A starts a timer (hereinafter also referred to as a “lock timer”) when the update of the ledger (A) is completed in step S11, and locks the ledger (A) for a lock period corresponding to the lock timer.

In step S13, the node (B) belonging to the group (B) 200B updates the ledger (B) by adding a new block to the ledger (B) during the lock period. The new block includes in a block header part thereof a block header of a block of the ledger (A) which is the latest at the time when the new block is joined, as the ledger information related to the ledger (A), and includes in a transaction data part of the new block transaction data related to at least one transaction in the group (B) 200B. Subsequently, when no transaction is present, the node (B) belonging to the group (B) 200B waits until a transaction occurs.

In step S14, the node (A) belonging to the group (A) 200A updates the ledger (A) by adding a new block to the ledger (A) after the lock timer expires. The new block includes in a block header part thereof a hash value calculated from the previous block of the ledger (A), and includes in a transaction data part of the new block transaction data for at least one transaction in the group (A) 200A and ledger information related to the ledger (B). The ledger information includes a hash value calculated from a block of the ledger (B) which is the latest at the time when a block is added, and a chain ID indicating the ledger (B). The ledger information may further include a block height that is a block number of the block added to the ledger (B).

In step S15, the node (A) belonging to the group (A) 200A starts the lock timer when the update of the ledger (A) is completed in step S14, and locks the ledger (A) for the lock period corresponding to the lock timer. The ledger (B) is assumed not to have been updated during this lock period.

In step S16, the node (A) belonging to the group (A) 200A updates the ledger (A) by adding a new block to the ledger (A) after the lock timer expires. The new block includes in a block header part thereof a hash value calculated from the previous block of the ledger (A) and includes in a transaction data part of the new block transaction data for at least one transaction in the group (A) 200A.

In step S17, the node (A) belonging to the group (A) 200A starts the lock timer when the update of the ledger (A) is completed in step S16, and locks the ledger (A) for the lock period corresponding to the lock timer.

As described above, each time the node (A) belonging to the group (A) 200A updates the ledger (A), the node (A) locks the ledger (A) for a certain period from the update. While the ledger (A) is locked, transaction data generated in the group (A) 200A fails to be stored in the ledger (A).

Accordingly, during the lock period, the proposer, which is a node that generates a block to be added to the ledger (A), may hold the transaction data. However, when a node having a low specification is a proposer, a concern exists in that the node fails to hold the transaction data. Alternatively, during the lock period, the node having caused the transaction may hold the transaction data of the transaction. However, when a node having a low specification generates a transaction, a concern exists in that the node cannot hold transaction data.

In the embodiment, when a transaction in the node (A) belonging to the group (A) 200A occurs within the lock period, the node (A) holds transaction data related to the transaction when the node (A) has a margin of the memory capacity for holding the transaction data (hereinafter referred to as a “memory margin”). On the other hand, when the node (A) does not have the margin, another node having a memory margin is caused to hold the transaction data. Thus, even when a node having a low specification generates a transaction during the lock period, the transaction data can be held by causing another node to hold the transaction data. As described above, when a node having a margin of the specification (specifically, the memory capacity) holds transaction data, even a node having a low specification can participate in a blockchain group having a hierarchical structure in which the lock technique is adopted.

Here, when a transaction in the node (A) belonging to the group (A) 200A occurs within the lock period, the node (A) may cause another node belonging to a group in a layer higher than the layer of the group (A) 200A to hold the transaction data when the node (A) has no memory margin and no other node (A) in the group (A) 200A has a memory margin. Since the group in the upper layer is formed by nodes having a higher specification, the group can be easily caused to hold the transaction data.

When the node (A) belonging to the group (A) 200A is not a proposer and holds transaction data during the lock period, the node (A) transmits the transaction data held by the node (A) to the proposer when the lock period ends. Thus, the proposer can generate a new block of the ledger (A) using the held transaction data. The proposer may be a node having a high specification indicated by specification information in the ledger (A) in the group (A) 200A. That is, the proposer may be a preset node group (A) 200A. The proposer may be a parent node.

In the embodiment, the ledger (A) includes memory margin information related to the memory capacities of the nodes (A) belonging to the group (A) 200A. When a transaction in the node (A) belonging to the group (A) 200A occurs within the lock period and the node (A) has no a memory margin, the node (A) determines another node to hold transaction data from the group (A) 200A based on memory margin information included in a ledger (A). Thus, when the node (A) having a low specification causes transaction data to occur, a node having a specification with sufficient margin can be searched for by using the common ledger (A).

In response to participation of a new node (A) in the group (A) 200A, the node (A) belonging to the group (A) 200A updates the ledger (A) to include, in the memory margin information in the ledger (A), information related to the memory capacity of the new node (A). That is, when a new node (A) participates in the group (A) 200A, information related to the memory capacity of the new node (A) is stored in the ledger (A). Thus, the ledger (A) can be provided with information related to the memory capacities of all the nodes (A) belonging to the group (A) 200A.

If a transaction in the node (A) belonging to group (A) 200A has no memory margin when a transaction in the node A occurs within the lock period, the node (A) transmits flag information (hereinafter referred to as a “margin flag”) indicating that the node A has no memory margin, to another node (specifically another node with a memory margin) along with the transaction data. The flag information is managed in the group (A) 200A as a part of the memory margin information in the ledger (A). This enables the ledger (A) to be provided with information related to a real-time memory margin of each node (A) in the group (A) 200A.

As described above, according to the embodiment, when a node having a low specification causes transaction data to occur during the lock period, the node searches for another node having a memory margin and causes the other node to hold the transaction data instead of the node. When each node participates in the group, the specification information (in particular, the memory margin) is stored in the ledger, and thus a node having a memory margin can be searched for using the ledger.

For example, the memory margin information of each node stored in the ledger may be the “memory size” and the “margin flag” of each node. The “memory size” is the size (capacity) of the memory determined by the specifications of the node. The “memory” may be any memory capable of storing transaction data, and may be a non-volatile memory and/or a volatile memory. The “margin flag” is managed as follows.

First, when a node is newly registered (i.e., participates in the group), information related to the performance (memory size) of the node is stored in the ledger in the group. At this time, the “margin flag”=ON (“1”) is set as an initial value when the memory size is equal to or larger than the specified value, and the “margin flag”=OFF (“0”) is set as an initial value when the memory size is smaller than the specified value.

Second, when a transaction occurs, the margin flag is updated by the next STEP1 to STEP3.

STEP1: The remaining memory capacity of the node is checked when a transaction occurs in the node.

STEP2: If “size of transaction data≤remaining memory capacity”, the “margin flag” is set to ON. On the other hand, if “size of transaction data>remaining memory capacity”, the “margin flag” is set to OFF.

STEP3: The transaction data and the margin flag are transmitted to another node having a memory margin.

The other node having a memory margin returns Ack (acknowledgement) upon having received the transaction data normally, and returns Nak (negative acknowledgement) upon having failed to receive the transaction data normally. When the other node having a memory margin fails to receive the transaction data because the other node is sleeping or the like, the other node returns nothing.

When no other node in the group has a memory margin, the node having caused the transaction data to occur transfers, via the parent node of the group, the transaction data to another node having a memory margin in the upper layer group. Alternatively, a method can be used in which an external database is used in preparation for a case where no other node in the group has a memory margin. However, a problem with the use of an external database is that security is lower than in the use of the ledger.

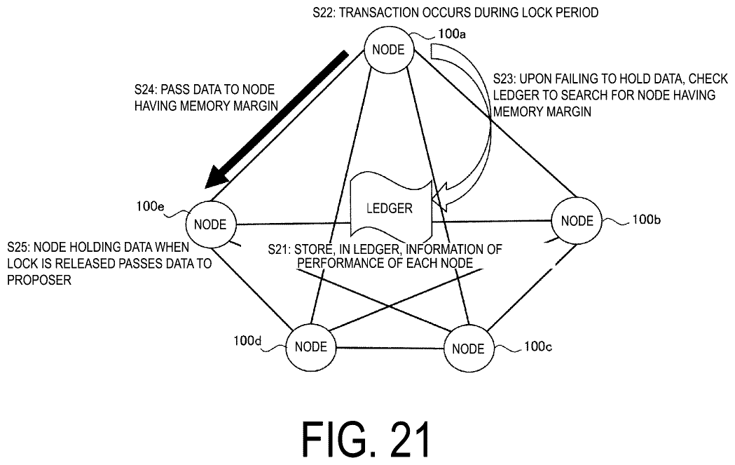

FIG. 21 is a diagram illustrating an example of operations according to the embodiment. In FIG. 21, a group (here, a “group (X)”) including nodes 100a to 100e is assumed to be formed, with each node 100 holding a ledger (here, a “ledger (X)”) specific to the group (X). Each node 100 manages the lock timer in which the common timer value is set, starts the lock timer each time the ledger (X) is updated, and locks the ledger (X) during the operation of the lock timer (that is, during the lock period).

As illustrated in FIG. 21, in step S21, when each node 100 is newly registered (i.e., participates in the group (X)), information (including memory margin information) of the performance of the node is stored in the ledger (X). At this time, when the memory size is equal to or larger than the specified value, “margin flag” =ON is set as an initial value, and when the memory size is smaller than the specified value, “margin flag”=OFF is set as an initial value. For example, it is assumed that “margin flag”=OFF for the nodes 100a and 100d, and “margin flag”=ON for the node 100e.

In step S22, the node 100a causes transaction data to occur during the lock period of the ledger (X).

In step S23, since the node 100a does not have a memory margin for holding the transaction data, the node SL checks the memory margin information included in the ledger (X) and searches for another node having a memory margin. That is, based on the ledger (X), the node 100a determines, from the group (X), another node that is caused to hold the transaction data. Here, the node 100a is assumed to determine to cause the node 100e having a memory margin to hold the transaction data. Note that, when no other node in the group (X) has a memory margin, the node 100a may determine to cause, via the parent node in the group (X), another node of a group in a layer higher than the layer of the group (X) to hold the transaction data.

In step S24, the node 100a passes the transaction data to the node 100e having a memory margin. The node 100e returns Ack (positive response) upon having received the transaction data normally, and returns Nak (negative response) upon having failed to receive the transaction data normally. Here, the node 100e is assumed to have received the transaction data normally. The node 100e holds the transaction data. However, the node 100e is assumed not to be a proposer.

In step S25, the node 100e passes the transaction data to the proposer upon expiry of the lock timer (upon unlocking). The proposer may be one of the nodes 100a to 100d. The proposer updates the ledger (X) by generating a new block containing the transaction data and adding the new block to the ledger (X). The new block is shared by the nodes in the group (X), and each node in the group (X) updates the ledger (X).

As described above, when the node 100e having a margin of the specification (to be specific, the memory capacity) holds the transaction data during the lock period, even a node having a low specification can participate in a block chain group having a hierarchical structure in which the lock technique is adopted.

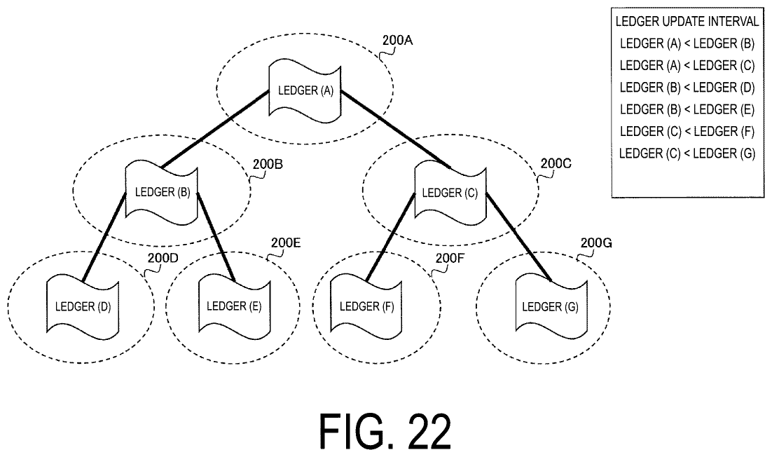

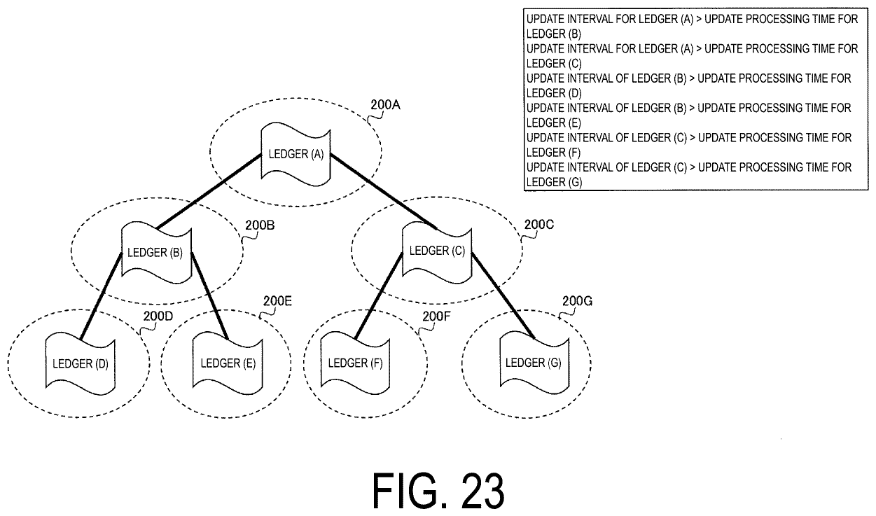

A method for setting the lock period according to the embodiment will be described. As described above, the lock period is specified by the lock timer. The lock timer is individually set for each group and specifies an update interval for the ledger in the group. FIG. 22 and FIG. 23 are diagrams for describing a method for setting the lock period according to the embodiment.

In the example illustrated in FIG. 22 and FIG. 23, the hierarchically structured network 10 includes groups 200A to 200G and includes three layers. The groups 200A to 200G manage the ledgers (A) to (G), respectively. The group 200A is a group in the highest layer, the groups 200D to 200G are groups in the lowest layer, and the groups 200B and 200C are groups in the intermediate layer.

Each node 100 belonging to each group 200 manages the lock timer specific to the group. The value of the lock timer in a certain group 200, that is, the ledger update interval in the group 200 is determined by the occurrence frequency of transactions in the group 200 and the sleep time of the node 100 participating in the group 200.

However, as illustrated in FIG. 22, the ledger update interval in the group 200 is set to satisfy “lock timer for the upper layer <lock timer for the lower layer”. That is, the ledger update interval is set in such a manner that the value of the lock timer (ledger update interval) is smaller for the upper layer and larger for the lower layer. For example, the value of the lock timer used in the group 200A is smaller than the value of the lock timer used in the group 200B. Since the performance (specification) of the node 100 is lower in the lower layer, even the node 100 having low performance can participate in the blockchain group by setting a larger value of the lock timer (ledger update interval) for the lower layer.

As illustrated in FIG. 23, “lock timer for the upper layer>ledger update processing time in the lower layer” is set. The ledger update processing time refers to a time (required time) required for the update processing for the ledger. For example, the value of the lock timer used in the group 200A is larger than the update processing time for the ledger (B) in the group 200B. The setting as described above allows suppression of occurrence of a situation in which the ledger in the upper layer is updated during the ledger update processing in the lower layer.

Even with this setting, the ledger in the upper layer may be updated during the ledger update processing in the lower layer. For example, a situation may occur in which the ledger (A) in the group 200B is updated during the ledger update processing for the ledger (B) in the group 200A. Hereinafter, a group in a certain layer is also referred to as a “parent group”, a ledger managed by the parent group is also referred to as a “parent ledger”, a group in a layer immediately below the certain layer is also referred to as a “child group”, and a ledger managed by the child group is also referred to as a “child ledger”.

When the parent ledger is updated before the child ledger is updated, the parent node of the child group provides notification of update of the parent ledger. In this case, the update of the child ledger fails, and the update processing for the child ledger is immediately performed again. For example, when the ledger (A) in the group 200B is updated during the update processing for the ledger (B) in the group 200A, the parent node in the group 200B notifies the other nodes in the group 200B that the ledger (A), which is the parent ledger, has been updated. In this case, each node in the group 200B considers that the update processing for the ledger (B) has failed, and updates the ledger (B) again. That is, upon detecting that the ledger (A) has been updated during the update processing for the ledger (B), each node in the group 200B determines that the update of the ledger (B) has failed and performs the update processing for the ledger (B) again. To be specific, when the update processing for the ledger (B) fails, each node in the group 200B re-generates a block to which a transaction in the group 200B during the failure is also added, and performs the update processing of the ledger (B). Note that even when a plurality of blocks of the child ledger is generated from the same parent ledger, each block can be updated in time for the update of the parent ledger.

However, when the update of the child ledger fails continuously, the lock timer for the parent ledger may be short. Thus, when the update of the child ledger fails continuously, the lock timer for the parent ledger is set for an extended time. For example, upon detecting that the update of the ledger (B) has continuously failed a predetermined number of times, each node belonging to the group 200A extends the lock period used in the group 200A, that is, sets the lock timer for the ledger (A) for an extended time.

For the update of the child ledger, the child group notifies the parent group of information of update of the child ledger. When the update of the parent ledger and the information notification of the update of the child ledger are performed at the same time, the information notification of the update of the child ledger needs to come before the parent ledger update processing, and thus the update of the parent ledger is prioritized. Thus, the update of the child ledger is established after the information can be input to the parent ledger.

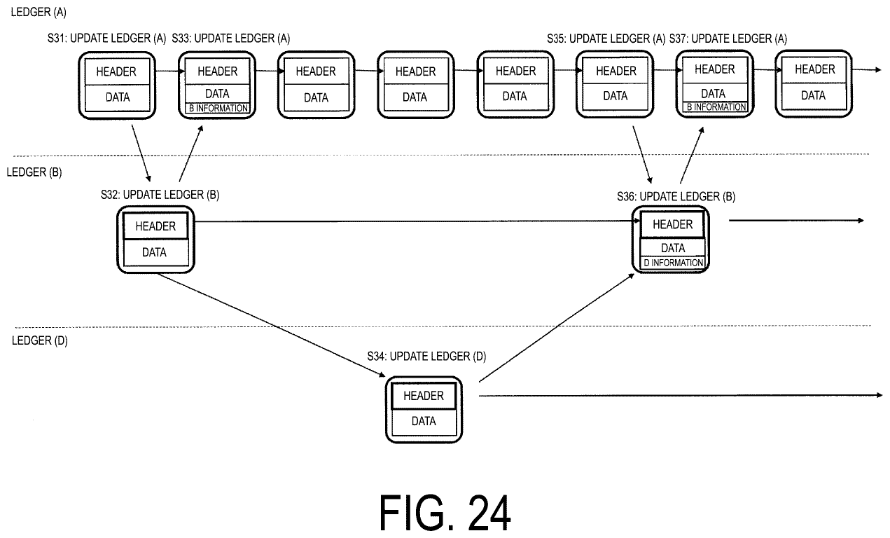

FIG. 24 is a diagram illustrating Specific Example 1 of operations related to ledger locking according to the embodiment. Specific Example 1 assumes that the groups 200A, 200B, and 200D respectively manage the ledgers (A), (B), and (D), that the group 200A is the parent group of the group 200B, and that the group 200B is the parent group of the group 200D. In other words, the group 200B is a child group of the group 200A, and the group 200D is a child group of the group 200B.

As illustrated in FIG. 24, in step S31, each node in the group 200A updates the ledger (A) and then locks the ledger (A) for the lock period of the ledger (A) from the update. The lock period of the ledger (A) is longer than the update processing time for the child ledger (B).

In step S32, each node in the group 200B updates the ledger (B) using the parent ledger (A) during the lock period of the parent ledger (A), and then locks the ledger (B) for the lock period of the ledger (B) from the update. Here, the lock period of the ledger (B) is longer than the lock period of the parent ledger The lock period of the ledger (B) is longer than the update processing time for the child ledger (D).

In step S33, when the lock period of the ledger (A) ends, each node in the group 200A updates the ledger (A) using the child ledger (B) updated during the lock period, and then locks the ledger (A) for the lock period of the ledger (A) from the update.

In step S34, each node in the group 200D updates the ledger (D) using the parent ledger (B) during the lock period of the parent ledger (B), and then locks the ledger (D) for the lock period of the ledger (D) from the update. Here, the lock period of the ledger (D) is longer than the lock period of the parent ledger.

In step S35, each node in the group 200A updates the ledger (A) and then locks the ledger (A) for the lock period of the ledger (A) from the update.

In step S36, during the lock period of the parent ledger (A), each node in the group 200B updates the ledger (B) using the latest parent ledger (A) at that point in time and the child ledger (D) updated during the lock period of the ledger (B), and then locks the ledger (B) for the lock period of the ledger (B) from the update.

In step S37, when the lock period of the ledger (A) ends, each node in the group 200A updates the ledger (A) using the child ledger (B) updated during the lock period, and then locks the ledger (A) for the lock period of the ledger (A) from the update.

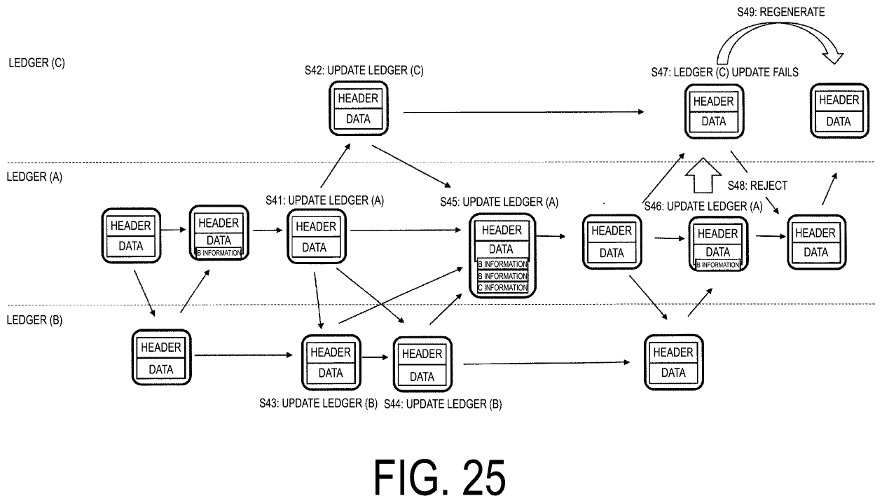

FIG. 25 is a diagram illustrating Specific Example 2 of operations related to ledger locking according to the embodiment. Specific Example 2 assumes that the groups 200A, 200B, and 200C respectively manage the ledgers (A), (B), and (C) and that the group 200A is the parent group of each of the groups 200B and 200C. In other words, each of the groups 200B and 200C is a child group of the group 200A.

As illustrated in FIG. 25, in step S41, each node in the group 200A updates the ledger (A) and then locks the ledger (A) for the lock period of the ledger (A) from the update.

In step S42, each node in the group 200C updates the ledger (C) using the latest parent ledger (A) at that point in time during the lock period of the parent ledger (A), and then locks the ledger (C) for the lock period of the ledger (C) from the update.

In step S43, each node in the group 200B updates the ledger (B) using the latest parent ledger (A) at that point in time during the lock period of the parent ledger (A), and then locks the ledger (B) for the lock period of the ledger (B) from the update.

In step S44, when the lock period of the ledger (B) ends during the lock period of the parent ledger (A), each node in the group 200B updates the ledger (B) using the latest parent ledger (A) at that point in time, and then locks the ledger (B) over the lock period of the ledger (B) from the update.

In step S45, when the lock period of the ledger (A) ends, each node in the group 200A updates the ledger (A) using the child ledgers (B) and (C) updated during the lock period. Here, during the lock period of the ledger (A), the child ledger (B) is updated twice (steps S43 and S44). Each node in the group 200A updates the ledger (A) to include, in the ledger (A), the ledger information (B information) in each of the two blocks of the child ledger (B) added in the steps S43 and S44. By including the height in the ledger information, the ledger information in each of the two blocks can be identified by the height. During the lock period of the ledger (A), the child ledger (C) is updated once (step S42). Each node in the group 200A updates the ledger (A) to include, in the ledger (A), the ledger information (C information) in the block of the child ledger (C) added in step S42. Since each of the B information and the C information includes a chain ID, which child ledger the information corresponds to can be determined based on the chain ID.

Then, in step S46, each node in the group 200A updates the ledger (A) and then locks the ledger (A) for a lock period of the ledger (A) from the update. Here, it is assumed that the update processing for the ledger (C) is being performed when the ledger (A) has been updated.

In step S47, upon detecting that the parent ledger (A) has been updated during the update processing for the ledger (C), each node in the group 200C determines that the update processing for the ledger (C) has failed. In this case, even when each node in the group 200A is notified of information of update of the ledger (C) from a node in the group 200C, the node in the group 200A rejects the notification (step S48).

In step S49, in response to a failure in the update processing for the ledger (C), each node in the group 200C re-generates a block to which a transaction in the group 200C during the failure is also added, and performs the update processing for the ledger (C) again.

### Flow Example of Basic Operations

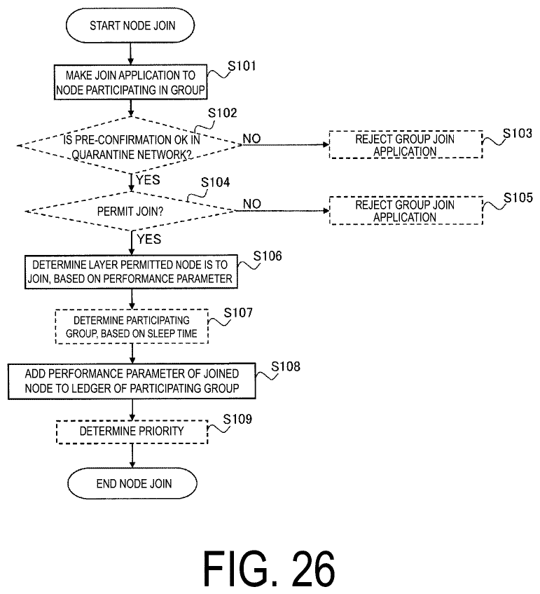

A flow example of basic operations according to the embodiment will be described with reference to FIGS. 26 to 29.

### (1) Flow Example of when Node is Joined

FIG. 26 is a diagram illustrating a flow example of when a node joins the hierarchically structured network 10 according to the embodiment. In FIG. 26, dashed lines indicate steps which may be omitted.

In step S101, a newly joined node makes a join application to a node already participating in the group.

In step S102, the node that has received the join application or another node performs pre-confirmation whether the node having made the join application has a calculation ability, is in a fraudulent state, and the like using a quarantine network, for example.

When the result of the pre-confirmation is NG (step S102: NO), in step S103, the node having received the join application or another node rejects the join application. On the other hand, when the result of the pre-confirmation is OK (step S102: YES), the processing proceeds to step S104.

In step S104, the node that has received the join application or another node determines whether to permit the join application. An administrator may determine how to permit the node to join. As for this method, whether to permit the node to join may be determined based on voting by all or some of the nodes. For a public type (free participation) group, step S104 may be skipped.

Upon determining that the node is not permitted to join (step S104: NO), in step S105, the node that has received the join application or another node rejects the join application. On the other hand, upon determining that the node is permitted to join (step S104: YES), the processing proceeds to step S106.

In step S106, the node that has received the join application or another node determines a layer which the newly joined node is to join (to be located in), in accordance with the performance of the newly joined node. Here, a method of determining the layer may be automatic determination by comparing a preset threshold value with the performance parameter. The method of determining the layer may be determination based on performance superiority or inferiority to another node. The method of determining the layer may be determination based on voting by all or some of the nodes.

In step S107, the node that has received the join application or another node determines the group that the newly joined node is to join (to be located in), in accordance with the sleep time of the newly joined node. Here, the method of determining the group may be automatic determination by comparing a preset threshold value with the sleep time. The method of determining the group may be determination by comparing the sleep time with that of another node. Alternatively, the method of determining the group may be determination based on voting by all or some of the nodes. Note that when the newly joined node joins the uppermost layer or when only one group is in the same layer, step S107 may be skipped.

In step S108, each node belonging to the group, which the newly joined node participates in, adds the performance parameter of the newly joined node to the ledger of the node. As described above, the ledger stores therein the performance parameter of each node participating in the group.

In step S109, the node that has received the join application or another node determines a priority of the newly joined node, in accordance with the performance of the newly joined node. For agreement on the priority, the same processing as and/or similar processing to that for a normal transaction consensus may be performed.

### (2) Flow Example of Parent Node Rotation

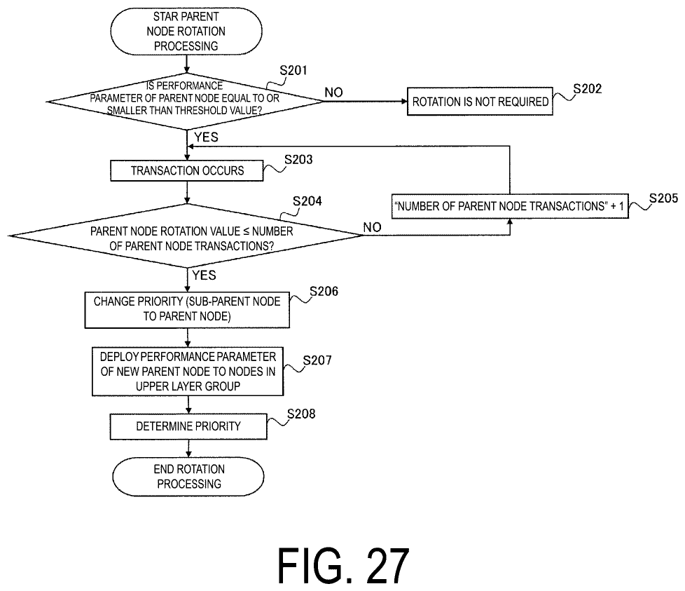

FIG. 27 is a diagram illustrating a flow example of parent node rotation in the hierarchically structured network 10 according to the embodiment.

In step S201, the parent node or another node determines whether the performance parameter of the parent node is equal to or smaller than a threshold value. When the performance parameter of the parent node is greater than the threshold value (step S201: NO), no parent node rotation is required (step S202). On the other hand, when the performance parameter of the parent node is equal to or smaller than the threshold value (step S201: YES), the parent node rotation is enabled.

In step S203, a transaction involving the parent node occurs.

In step S204, the parent node or another node determines whether the number of parent node transactions has reached a parent node rotation value. When the number of parent node transactions has not reached the parent node rotation value (step S204: NO), the number of parent node transactions is incremented (1 is added) in step S205.

On the other hand, when the number of parent node transactions has reached the parent node rotation value (step S204: YES), each node in the group to which the parent node belongs changes the priority in the group in step S206. For example, the node of the parent node (first priority) is changed to the lowest priority, the priorities of the other nodes are raised by one, and the sub-parent node is set as a new parent node.

In step S207, the new parent node or another node deploys the performance parameter of the new parent node to the nodes in the upper layer group (notifies the nodes in the upper layer group of the performance parameter of the new parent node). Each node in the upper layer group adds the performance parameter of the new parent node to the upper layer ledger.

In step S208, the nodes belonging to the upper layer group (including the new parent node) determine priorities in the upper layer group. Since the performance parameter of the new parent node is lower than that of the previous parent node, the new parent node does not have the first priority in the upper layer group, but a condition for the new parent node to have the second or lower priority may be included as exceptional processing.

### (3) Flow Example of when Node Joins Lower Layer

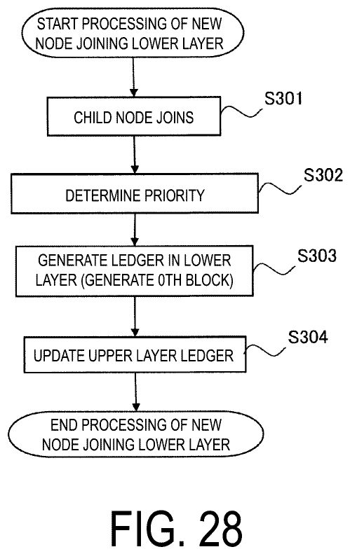

FIG. 28 is a diagram illustrating a flow example of when a node joins the lower layer (joins a lower layer group) in the hierarchically structured network 10 according to the embodiment.

In step S301, a child node joins the lower layer.

In step S302, a priority of the node that has joined the lower layer is determined. When one node joins a new group, the node requisitely receives second priority, and the node becomes a sub-parent node.

In step S303, a lower layer ledger of the lower layer (new lower layer group) is generated. As described above, the lower layer ledger may include a block header and a parent chain ID of the current upper layer ledger.

In step S304, the upper layer ledger is updated in response to the generation of the lower layer ledger. As described above, the upper layer ledger may include information (a hash value, a chain ID, or the like) of the lower layer ledger.

### (4) Flow Example of when Node Is Removed

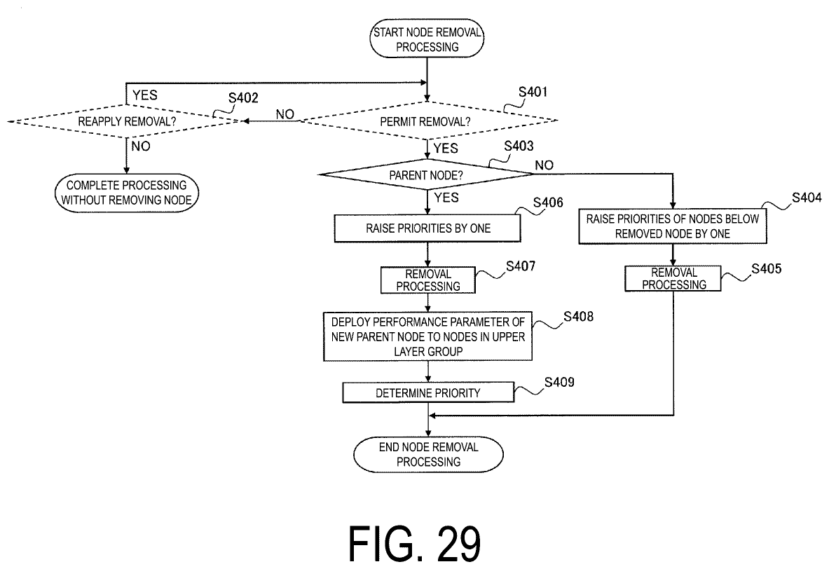

FIG. 29 is a diagram illustrating a flow example of when a node is removed in the hierarchically structured network 10 according to the embodiment. In FIG. 29, dashed lines indicate steps which may be omitted.

In step S401, a node in the group to which a removal target node requested to be removed belongs or another node determines whether to permit the removal request, by using a quarantine network, for example. For example, it is determined whether inconsistency or the like does not occur even when the node requested to be removed is removed.

When the removal request is rejected (not permitted) (step S401: NO), in step S402, the removal target node determines whether to reapply the removal request. Here, a restriction may be imposed so that the re-application is made after removing the cause of the non-permission. When the removal request is reapplied (step S402: YES), the processing returns to step S401.

In step S403, whether the removal target node is a parent node is determined. When the removal target node is not a parent node (step S403: NO), the priorities below the removal target node are raised by one (step S404), and the removal target node is removed from the group (S405). Note that the removal processing is performed in the same manner as and/or a similar manner to a normal transaction.

On the other hand, when the removal target node is a parent node (step S403: YES), the priorities of the nodes in the group are raised by one (step S406), and the removal target node is removed from the group (S407). Note that the removal processing is performed in the same manner as and/or a similar manner to a normal transaction. In step S408, the performance parameter of the new parent node is deployed (or given by notification) to the nodes of the upper layer group. In step 409, the nodes belonging to the upper layer group (including the new parent node) determine priorities in the upper layer group. Since the performance parameter of the new parent node is lower than that of the previous parent node, the new parent node does not have the first priority in the upper layer group, but a condition for the new parent node to have the second or lower priority may be included as exceptional processing.

### Operation Flow Example Related to Ledger Locking

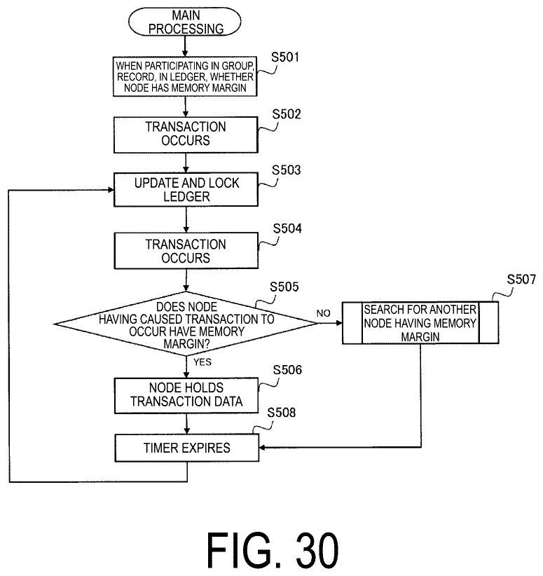

An operation flow example related to ledger locking according to the embodiment will be described with reference to FIGS. 30 to 38.

### (1) Main Processing for Ledger Locking

FIG. 30 is a diagram illustrating an example of main processing for ledger locking according to the embodiment.

In step S501, when a node 100 participates in a certain group 200, each node 100 in the group 200 stores the memory margin information of the newly participating node 100 in the ledger in the group 200.

In step S502, the node 100 in the group 200 causes a transaction to occur to generate transaction data.

In step S503, each node 100 in the group 200 updates the ledger in the group 200 in accordance with the transaction having occurred in step S502, and starts the lock timer to lock the ledger.

In step S504, the node 100 in the group 200 causes a transaction to occur to generate transaction data.

In step S505, the node 100 that has caused a transaction to occur in step S504 determines whether the node 100 has a memory margin.

Upon determining that the node 100 has a memory margin (step S505: YES), the node 100 holds the transaction data in the node 100 in step S506.

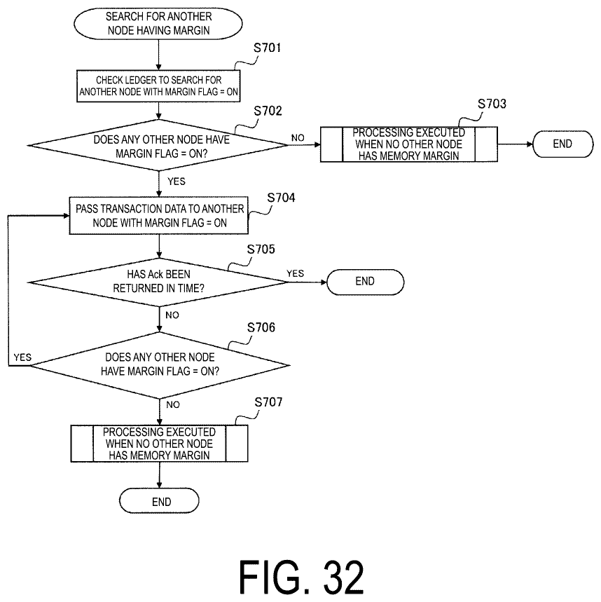

On the other hand, upon determining that the node 100 has no memory margin (step S505: NO), the node 100 executes processing for searching for another node 100 having a memory margin in step S507. The details of the processing will be described below with reference to FIG. 32.

In step S508, each node 100 in the group 200 detects the expiration of the lock timer, releases the ledger locking, and returns the processing to step S503.

### (2) Transaction Data Processing

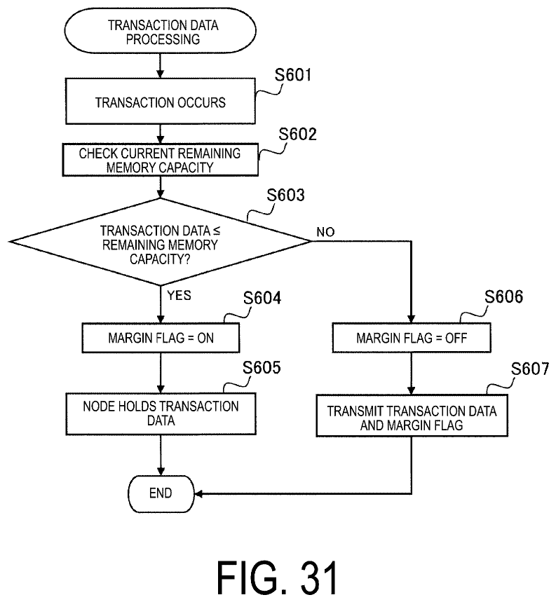

FIG. 31 is a diagram illustrating an example of transaction data processing according to the embodiment.

In step S601, the node 100 in the group 200 causes a transaction to occur to generate transaction data.

In step S602, the node 100 checks the current remaining memory capacity of the node 100.

In step S603, the node 100 determines whether the remaining memory capacity is equal to or larger than the size of the transaction data. Upon determining that the remaining memory capacity is equal to or larger than the size of the transaction data (step S603: YES), the node 100 sets the margin flag to ON (step S604) and holds the transaction data in the node 100.

On the other hand, upon determining that the remaining memory capacity is less than the size of the transaction data (step S603: NO), the node 100 sets the margin flag to OFF (step S606), and transmits the transaction data and the margin flag to another node 100.

### (3) Processing for Searching for Another Node Having Memory Margin

FIG. 32 is a diagram illustrating an example of processing for searching for another node 100 having a memory margin according to the embodiment.

In step S701, the node 100 that has caused a transaction to occur checks the ledger held by the node 100 (to be specific, the ledger in the group 200 to which the node 100 belongs), and searches for another node 100 whose margin flag=ON.

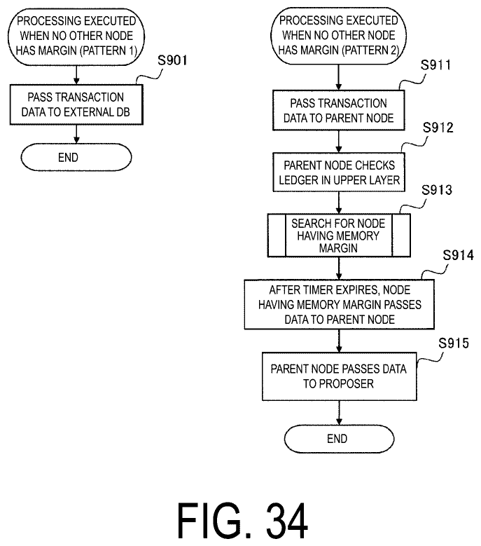

In step S702, the node 100 determines whether any other node 100 in the group 200 has the margin flag=ON. Upon determining that no other node 100 has the margin flag=ON (step S702: NO), the node proceeds to processing executed when no other node 100 in the group 200 has a memory margin (step S703). Details of the processing will be described below with reference to FIG. 34.

On the other hand, upon determining that another node 100 has the margin flag=ON (step S702: YES), the node 100 transmits the transaction data and the margin flag to the other node 100 with the margin flag=ON in step S704. Then, when Ack is returned from the other node 100 with the margin flag=ON (step S705: YES), the processing is ended.

When no Ack is returned from the other node 100 with the margin flag=ON (step S705: NO), the node 100 determines, in step S706, whether any other node 100 in the group 200 has the margin flag=ON. Upon determining that no other node 100 in the group 200 has the margin flag=ON (step S706: NO), the node proceeds to processing executed when no other node 100 in the group 200 has a memory margin (step S707). Details of the processing will be described below with reference to FIG. 34.

Upon determining that another node 100 in the group 200 has the margin flag=ON (step S706: YES), the node 100 returns the processing to step S704 and transmits the transaction data and the margin flag to the other node 100.

### (4) Processing on Side of Node with Memory Margin

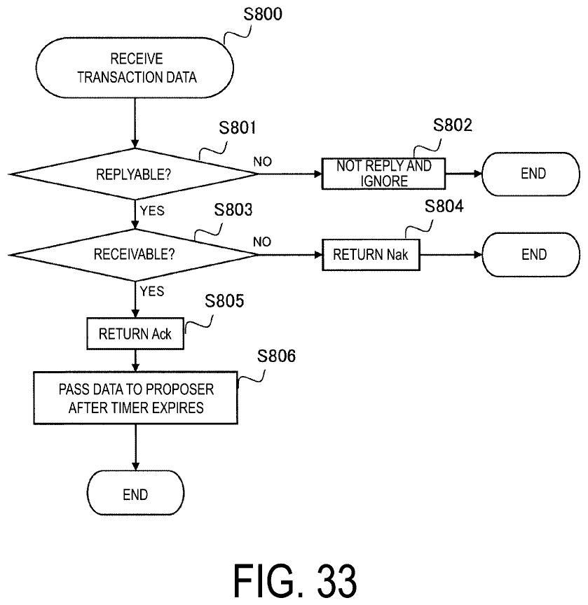

FIG. 33 is a diagram illustrating an example of processing on the side of the node 100 with a memory margin according to the embodiment.

In step S800, the node 100 having a memory margin receives transaction data. However, when the node 100 is in a sleep state, the transaction data cannot be received.

In step S801, the node 100 determines whether the node 100 can reply to the transaction data. When the reply is disabled (step S801: NO), the node 100 ignores the transaction data without making a reply (step S802).

When the reply is enabled (step S801: YES), the node 100 determines, in step S803, whether the transaction data has been successfully received. When the transaction data has failed to be received (step S803: NO), the node 100 returns Nak (step S804).

When the transaction data has been successfully received (step S803: YES), the node 100 returns Ack (step S805). Subsequently, when the lock timer expires, the node 100 passes the transaction data to the proposer (step S806). However, when the node 100 is a proposer, the node 100 generates a new block in the node 100 using the transaction data.

### (5) Processing Executed when No Other Node Has Memory Margin

FIG. 34 is a diagram illustrating an example of processing executed when no other node 100 in the group 200 has a memory margin according to the embodiment.

In pattern 1, in step S901, the node 100 that has caused a transaction to occur passes the transaction data to an external database (DB).

In pattern 2, the processing of the following steps S911 to 915 is performed. To be more specific, in step S911, the node 100 that has caused the transaction to occur passes the transaction data to the parent node 100 in the group 200 to which the node 100 belongs. However, when the node 100 is the parent node 100, step S911 is omitted.

The parent node 100 checks the parent ledger of the parent group 200 that is one level higher than the level of the group 200 to which the node 100 that has caused the transaction to occur belongs (step S912), and searches the parent group 200 for a node 100 having a memory margin (step S913).

Subsequently, when the lock timer expires in step S914, the node 100 in the parent group 200 having the memory margin passes the transaction data to the parent node 100. The parent node 100 passes the transaction data to the proposer in the group 200 (child group) to which the node 100 that has caused the transaction to occur belongs (step S915).

### (6) Processing Executed when Ledgers of Plurality of Child Groups Are Updated

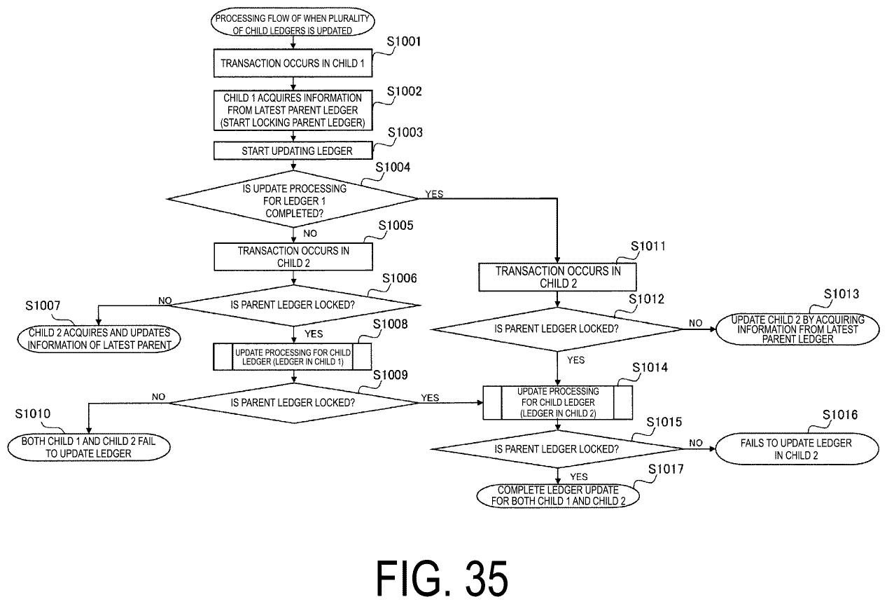

FIG. 35 is a diagram illustrating an example of processing executed when ledgers (child ledgers) of a plurality of child groups is updated according to the embodiment. Here, a transaction is assumed to occur in two child groups (referred to as “child 1” and “child 2”).

In step S1001, a transaction occurs in the node 100 in child 1.

In step S1002, the node 100 in child 1 acquires ledger information from the latest parent ledger in the parent group 100. Locking of the parent ledger starts.

In step S1003, the node 100 in child 1 starts update processing for the ledger in child 1.

When the update processing for the ledger in child 1 is not completed (step S1004: NO), a transaction occurs in the node 100 in child 2 (step S1005). Here, when the parent ledger is not locked (step S1006: NO), the node 100 in child 2 acquires ledger information from the latest parent ledger in the parent group 100 and updates the ledger in child 2, in step S1007. The parent ledger is locked. When the parent ledger is locked (step S1006: YES), the node 100 in child 1 performs update processing for the ledger in child 1 in step S1008. However, when the parent ledger is not locked (step S1009: NO), both child 1 and child 2 fail to update the ledger. When the parent ledger is locked (step S1009: YES), the processing proceeds to step S1015.

When the update processing for the ledger in child 1 is completed (step S1004: YES), a transaction occurs in the node 100 in child 2 (step S1011). Here, when the parent ledger is not locked (step S1012: NO), the node 100 in child 2 acquires ledger information from the latest parent ledger in the parent group 100 and updates the ledger in child 2, in step S1013. The parent ledger is locked. When the parent ledger is locked (step S1012: YES), the node 100 in child 2 performs update processing for the ledger in child 2 in step S1014. Here, when the parent ledger is not locked (step S1015: NO), child 2 fails to update the ledger (step S1016). When the parent ledger is locked (step S1015: YES), the update of the ledger succeeds (is completed) for both child 1 and child 2 (step S1017).

### (7) Processing Executed when Ledger in Child Group Is Updated Plurality of Times

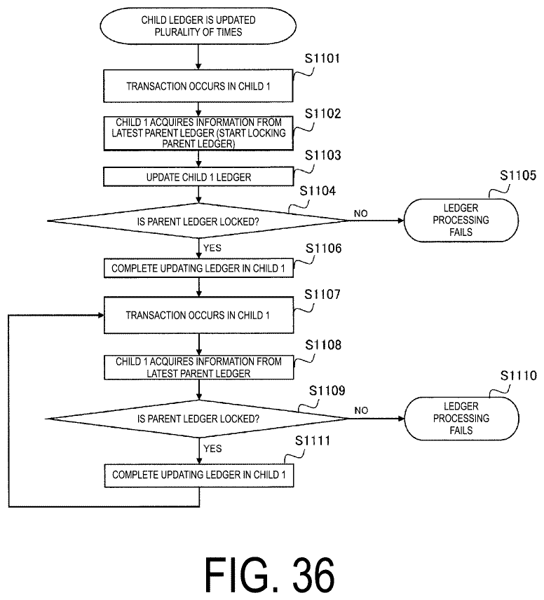

FIG. 36 is a diagram illustrating an example of processing executed when a ledger in a child group is updated a plurality of times according to the embodiment.

In step S1101, a transaction occurs in the node 100 in child 1.

In step S1102, the node 100 in child 1 acquires ledger information from the latest parent ledger in the parent group 100.

In step S1103, the node 100 in child 1 starts update processing for the ledger in child 1. Here, when the parent ledger is not locked (step S1104: NO), ledger updating in child 1 fails (step S1105). When the parent ledger is locked (step S1104: YES), the update processing for the ledger in child 1 is completed in step S1106.

In step S1107, a transaction occurs in the node 100 in child 1.

In step S1108, the node 100 in child 1 acquires ledger information from the latest parent ledger in the parent group 100.

In step S1109, the node 100 in child 1 starts update processing for the ledger in child 1. Here, when the parent ledger is not locked (step S1109: NO), ledger updating in child 1 fails (step S1110). When the parent ledger is locked (step S1109: YES), the update processing for the ledger in child 1 is completed in step S1111. Subsequently, the processing returns to step S1107.

### (8) Processing Related to Failure in Child Ledger Updating

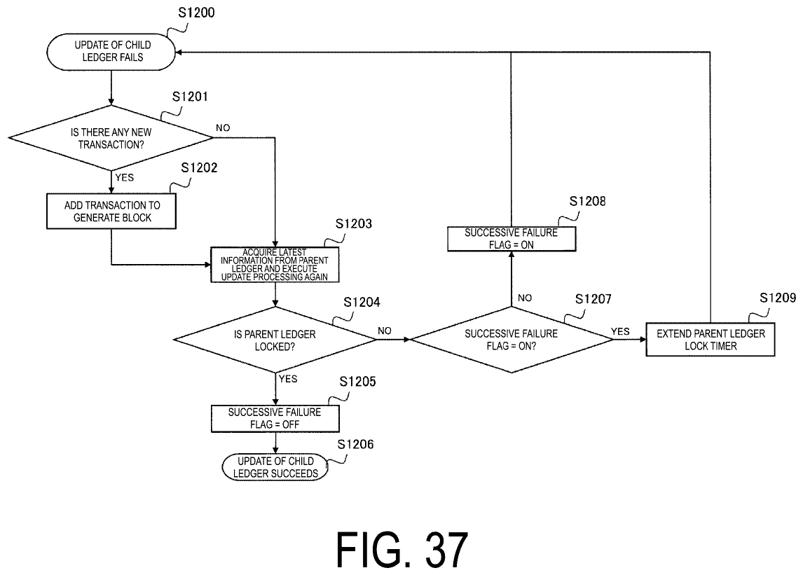

FIG. 37 is a diagram illustrating an example of processing executed when child ledger updating fails according to the embodiment.

In step S1200, ledger updating fails in a certain child group 200.

In step S1201, the node 100 in the child group 200 determines whether a new transaction is present in the child group 200. When a new transaction is present in the child group 200 (step S1201: YES), the node 100 (proposer) in the child group 200 adds the new transaction to generate a new block in step S1202, and the processing proceeds to step S1203. When no new transaction is present in the child group 200 (step S1201: NO), the processing proceeds to step S1203.

In step S1203, the node 100 in the child group 200 acquires ledger information from the latest parent ledger in the parent group 100 and starts update processing for the child group 200 again. Here, when the parent ledger is locked (step S1204: YES), the node 100 in the child group 200 sets a successive failure flag managed by the node 100=OFF (step S1205), and the update processing for the ledger in the child group 200 succeeds (is completed) (step S1206).

On the other hand, when the parent ledger is not locked (step S1204: NO), the node 100 in the child group 200 determines whether the successive failure flag managed by the node 100=ON, in step S1207. When the successive failure flag is not ON (step S1207: NO), the node 100 in the child group 200 sets the successive failure flag to ON in step S1208. When the successive failure flag=ON (step S1207: YES), the node 100 in the parent group 200 sets the lock timer of the parent group 200 for an extended time in step S1209.

### (9) Child Ledger Update Processing

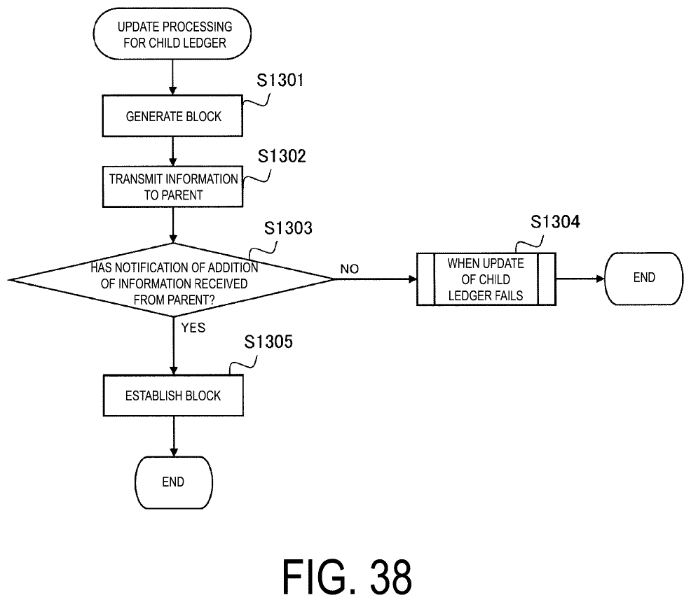

FIG. 38 is a diagram illustrating an example of child ledger update processing according to the embodiment.

In step S1301, the node 100 (proposer) in the child group 200 adds the new transaction to generate a new block. In this case, the new block has not been established.

In step S1302, the node 100 in the child group 200 notifies the parent group 200 of update information (the ledger information in the child group 200).

In step S1303, the node 100 in the child group 200 determines whether a notification has been received that indicates that the ledger information of the child group 200 has been added to the ledger in the parent group 200. When the notification has not been received (step S1303: NO), the ledger updating in the child group 200 fails in step S1304.

When the notification has been received (step S1303: YES), a new block in the child group 200 is established, and the ledger updating succeeds, in step S1305.

### OTHER EMBODIMENTS

The embodiment described above mainly assumes that the node 100 is a battery-driven device. However, the hierarchically structured network 10 may include an external power supply-driven device. For example, a device connected to an external power supply may be located in the uppermost layer in the hierarchically structured network 10.

The operation flows described above can be separately and independently implemented, and also be implemented in combination of two or more of the operation flows. For example, some steps of one operation flow may be added to another operation flow or some steps of one operation flow may be replaced with some steps of another operation flow. The order of steps in each operation flow described above is merely an example and may be changed as appropriate.

A program may be provided that causes a computer to execute each of the processing operations performed by the node 100. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing each of the processing operations performed by the node 100 may be integrated, and at least a part of the node 100 may be configured as a semiconductor integrated circuit (chip set, system on a chip (SoC)).

The phrases “based on” and “depending on” used in the present disclosure do not mean “based only on” and “depending only on,” unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

The present application claims priority to Japanese Patent Application No. 2022-104031 (filed on Jun. 28, 2022), the content of which is incorporated herein by reference in its entirety.

### SUPPLEMENTARY NOTE

Features relating to the embodiments described above are described below as supplements.

### Supplementary Note 1

A blockchain system in which a network with a hierarchical structure is formed by a plurality of nodes, wherein
a node belonging to a first group in a first layer different from a lowest layer is configured to manage a first ledger including transaction data related to a transaction in the first group, perform ledger locking to not update the first ledger during a lock period after the first ledger is updated, and
if a second ledger managed by a second group in a second layer lower than the first layer has been updated within the lock period when the lock period ends, update the first ledger to include, in the first ledger, ledger information related to the updated second ledger.

### Supplementary Note 2

The blockchain system according to Supplementary Note 1, wherein the node belonging to the first group is configured to include, in the first ledger as the ledger information, at least one selected from the group consisting of a chain ID indicating the second ledger, a hash value calculated from a new block of the second ledger, and a block height indicating a block number of the new block.

### Supplementary Note 3

The blockchain system according to Supplementary Note 1 or 2, wherein the node belonging to the first group is configured to, when a transaction in the node occurs within the lock period,
hold transaction data related to the transaction if the node has a margin of memory capacity for holding the transaction data, and
cause another node having the margin to hold the transaction data if the node does not have the margin.

### Supplementary Note 4

The blockchain system according to Supplementary Note 3, wherein the node belonging to the first group is configured to, when a transaction in the node belonging to the first group occurs within the lock period, cause another node belonging to a group in a layer higher than the first layer to hold the transaction data if the node does not have the margin and no other node in the first group has the margin.

### Supplementary Note 5

The blockchain system according to Supplementary Note 3 or 4, wherein the plurality of nodes includes a proposer that is a node configured to generate a new block for updating the first ledger, and
when the node belonging to the first group is not the proposer, the node is configured to transmit the transaction data held by the node to the proposer when the lock period ends.

### Supplementary Note 6

The blockchain system according to any one of Supplementary Notes 3 to 5 wherein the first ledger includes memory margin information related to a memory capacity of each node belonging to the first group, and
when a transaction in the node belonging to the first group occurs within the lock period, the node is configured to determine the other node to hold the transaction data from the first group, based on the memory margin information included in the first ledger if the node does not have the margin.

### Supplementary Note 7

The blockchain system according to Supplementary Note 6, wherein in response to a new node participating in the first group, the node belonging to the first group is configured to update the first ledger to include, in the memory margin information, information related to a memory capacity of the new node.

### Supplementary Note 8

The blockchain system according to Supplementary Note 6 or 7, wherein when a transaction in the node belonging to the first group occurs within the lock period, the node is configured to transmit, to the other node, flag information indicating that the node does not have the margin, together with the transaction data when the node does not have the margin, and
the flag information is managed in the first group as a part of the memory margin information.

### Supplementary Note 9

The blockchain system according to any one of Supplementary Notes 1 to 8, wherein a node belonging to the second group is configured to
perform ledger locking to not update the second ledger during a lock period after the second ledger is updated, and
when the lock period ends, update the second ledger to include, in the second ledger, information related to the updated ledger when a ledger managed by a group in a layer lower than the second layer has been updated within the lock period, and
the lock period used in the first group is shorter than the lock period used in the second group.

### Supplementary Note 10

The blockchain system according to Supplementary Note 9, wherein the lock period used in the first group is longer than a ledger update processing time required for update processing for the second ledger.

### Supplementary Note 11

The blockchain system according to any one of Supplementary Notes 1 to 10, wherein upon detecting that the first ledger has been updated during the update processing for the second ledger, a node belonging to the second group is configured to consider that update of the second ledger has failed, and perform the update processing for the second ledger again.

### Supplementary Note 12

The blockchain system according to Supplementary Note 11, wherein the node belonging to the first group is configured to extend the lock period used in the first group when a failure in update of the second ledger continuously occurs a predetermined number of times.

### Supplementary Note 13

The blockchain system according to any one of Supplementary Notes 1 to 12, wherein the second layer includes the second group and a third group, and
if a second ledger managed by the second group and a third ledger managed by the third group have been updated within the lock period when the lock period ends, the node belonging to the first group is configured to update the first ledger to include, in the first ledger, information related to the updated second ledger and information related to the updated third ledger.

### Supplementary Note 14

The blockchain system according to any one of Supplementary Notes 1 to 13, wherein each of the plurality of nodes is located, based on performance of the node, in a layer corresponding to the performance among a plurality of layers in the hierarchical structure.

### Supplementary Note 15

The blockchain system according to Supplementary Note 14, wherein the node belonging to the first group is configured to have higher performance than a node belonging to the second group.

### Supplementary Note 16

The blockchain system according to any one of Supplementary Notes 1 to 15 wherein the node belonging to the first group is configured to update the first ledger in accordance with each of a transaction in the first group and a transaction in the second group, and the node belonging to the second group is configured to not update the second ledger in accordance with a transaction in the first group but update the second ledger in accordance with a transaction in the second group.

### Supplementary Note 17

A node belonging to a first group in a first layer different from a lowest layer in a blockchain system in which a network with a hierarchical structure is formed by a plurality of nodes, the node including a processor configured to execute:
processing for managing a first ledger including transaction data related to a transaction in the first group;
processing for performing ledger locking to not update the first ledger during a lock period after the first ledger is updated; and
processing for, if a second ledger managed by a second group in a second layer lower than the first layer has been updated within the lock period when the lock period ends, updating the first ledger to include, in the first ledger, information related to the updated second ledger.

### Supplementary Note 18

A program causing a node belonging to a first group in a first layer different from a lowest layer in a blockchain system in which a network with a hierarchical structure is formed by a plurality of nodes, to execute:
processing for managing a first ledger including transaction data related to a transaction in the first group, processing for performing ledger locking to not update the first ledger during a lock period after the first ledger is updated, and
processing for, if a second ledger managed by a second group in a second layer lower than the first layer has been updated within the lock period when the lock period ends, updating the first ledger to include, in the first ledger, information related to the updated second ledger.

### REFERENCE SIGNS

10: Hierarchically structured network
100: Node
110: Communicator
120: Controller
121: Processor
130: Storage
140: Battery
200: Group

1. A blockchain system in which a network with a hierarchical structure is formed by a plurality of nodes, wherein
a node belonging to a first group in a first layer different from a lowest layer is configured to
manage a first ledger comprising transaction data related to a transaction in the first group,
perform ledger locking to not update the first ledger during a lock period after the first ledger is updated, and
if a second ledger managed by a second group in a second layer lower than the first layer has been updated within the lock period when the lock period ends, update the first ledger to include, in the first ledger, ledger information related to the updated second ledger.

2. The blockchain system according to claim 1, wherein
the node belonging to the first group is configured to include, in the first ledger as the ledger information, at least one selected from the group consisting of a chain ID indicating the second ledger, a hash value calculated from a new block of the second ledger, and a block height indicating a block number of the new block.

3. The blockchain system according to claim 1, wherein
the node belonging to the first group is configured to, when a transaction in the node occurs within the lock period,
hold transaction data related to the transaction if the node has a margin of memory capacity for holding the transaction data, and
cause another node having the margin to hold the transaction data if the node does not have the margin.

4. The blockchain system according to claim 3, wherein
the node belonging to the first group is configured to, when a transaction in the node occurs within the lock period, cause another node belonging to a group in a layer higher than the first layer to hold the transaction data if the node does not have the margin and no other node in the first group has the margin.

5. The blockchain system according to claim 3, wherein
the plurality of nodes comprises a proposer that is a node configured to generate a new block for updating the first ledger, and
when the node belonging to the first group is not the proposer, the node is configured to transmit the transaction data held by the node to the proposer when the lock period ends.

6. The blockchain system according to claim 3, wherein
the first ledger comprises memory margin information related to a memory capacity of each node belonging to the first group, and
when a transaction in the node belonging to the first group occurs within the lock period, the node is configured to determine the other node to hold the transaction data from the first group, based on the memory margin information comprised in the first ledger if the node does not have the margin.

7. The blockchain system according to claim 6, wherein
in response to a new node participating in the first group, the node belonging to the first group is configured to update the first ledger to include, in the memory margin information, information related to a memory capacity of the new node.

8. The blockchain system according to claim 6, wherein
when a transaction in the node belonging to the first group occurs within the lock period, the node is configured to transmit, to the other node, flag information indicating that the node does not have the margin, together with the transaction data when the node does not have the margin, and
the flag information is managed in the first group as a part of the memory margin information.

9. The blockchain system according to claim 1, wherein
a node belonging to the second group is configured to
perform ledger locking to not update the second ledger during a lock period after the second ledger is updated, and
when the lock period ends, update the second ledger to include, in the second ledger, information related to the updated ledger when a ledger managed by a group in a layer lower than the second layer has been updated within the lock period, and
the lock period used in the first group is shorter than the lock period used in the second group.

10. The blockchain system according to claim 9, wherein
the lock period used in the first group is longer than a ledger update processing time required for update processing for the second ledger.

11. The blockchain system according to claim 1, wherein
upon detecting that the first ledger has been updated during the update processing for the second ledger, a node belonging to the second group is configured to consider that update of the second ledger has failed, and perform the update processing for the second ledger again.

12. The blockchain system according to claim 11, wherein
the node belonging to the first group is configured to extend the lock period used in the first group when a failure in update of the second ledger continuously occurs a predetermined number of times.

13. The blockchain system according to claim 1, wherein
the second layer comprises the second group and a third group, and
if a second ledger managed by the second group and a third ledger managed by the third group have been updated within the lock period when the lock period ends, the node belonging to the first group is configured to update the first ledger to include, in the first ledger, information related to the updated second ledger and information related to the updated third ledger.

14. The blockchain system according to claim 1, wherein
each of the plurality of nodes is located, based on performance of the node, in a layer corresponding to the performance among a plurality of layers in the hierarchical structure.

15. The blockchain system according to claim 14, wherein
the node belonging to the first group is configured to have higher performance than a node belonging to the second group.

16. The blockchain system according to claim 1, wherein
the node belonging to the first group is configured to update the first ledger in accordance with each of a transaction in the first group and a transaction in the second group, and
the node belonging to the second group is configured to not update the second ledger in accordance with a transaction in the first group but update the second ledger in accordance with a transaction in the second group.

17. A node belonging to a first group in a first layer different from a lowest layer in blockchain system in which a network with a hierarchical structure is formed by a plurality of nodes, the node comprising a processor configured to execute:
processing for managing a first ledger comprising transaction data related to a transaction in the first group;
processing for performing ledger locking to not update the first ledger during a lock period after the first ledger is updated; and
processing for, if a second ledger managed by a second group in a second layer lower than the first layer has been updated within the lock period when the lock period ends, updating the first ledger to include, in the first ledger, information related to the updated second ledger.

18. A program causing a node belonging to a first group in a first layer different from a lowest layer in a blockchain system in which a network with a hierarchical structure is formed by a plurality of nodes, to execute:
processing for managing a first ledger comprising transaction data related to a transaction in the first group,
processing for performing ledger locking to not update the first ledger during a lock period after the first ledger is updated, and
processing for, if a second ledger managed by a second group in a second layer lower than the first layer has been updated within the lock period when the lock period ends, updating the first ledger to include, in the first ledger, information related to the updated second ledger.
